(19) United States
(12) Patent Application Publication
(10) Pub. No.: US 2021/0284805 A1
(43) Pub. Date: Sep. 16, 2021

(54) DESIGN OF LIGAND ATTACHMENT CHEMISTRY FOR HIGH CONDUCTIVITY POLYMER ELECTROLYTES

(71) Applicant: The Regents of the University of California, Oakland, CA (US)

(72) Inventors: Rachel A. Segalman, Santa Barbara, CA (US); Craig J. Hawker, Santa Barbara, CA (US); Raphaele Clement, Santa Barbara, CA (US); Javier Read de Alaniz, Santa Barbara, CA (US); Nicole Michenfelder-Schauser, Santa Barbara, CA (US); Peter Richardson, Santa Barbara, CA (US); Andrei Nikolaev, Santa Barbara, CA (US); Caitlin Sample, Santa Barbara, CA (US); Hengbin Wang, Santa Barbara, CA (US)

(73) Assignee: The Regents of the University of California, Oakland, CA (US)

(21) Appl. No.: 17/191,422

(22) Filed: Mar. 3, 2021

Related U.S. Application Data
(60) Provisional application No. 62/984,519, filed on Mar. 3, 2020.

(51) Int. Cl. C08G 77/32; C08G 77/28; C08G 77/20; H01M 10/0565

(52) U.S. Cl. CPC C08G 77/32; C08G 77/28; H01M 2300/0082; H01M 10/0565; H01M 2300/0091; C08G 77/20

(57) ABSTRACT

A composition of matter useful in an electrolyte, comprising a polymer including: a repeat unit, the repeat unit including a backbone section; and a side chain attached to the backbone section, wherein the side chain includes a ligand moiety configured to ionically bond to a lithium ion. The polymer has a glass transition temperature (e.g., less than room temperature) wherein the polymer is in a solid state during operation of a lithium ion battery comprising an electrolyte including the polymer.

### CROSS REFERENCE TO RELATED APPLICATIONS

This application claims the benefit under 35 U.S.C. Section 119(e) of co-pending and commonly-assigned U.S. Provisional Patent Application No. 62/984,519, filed Mar. 3, 2020, by Rachel Segalman, Craig Hawker, Raphaele Clement, Javier Read de Alaniz, Nicole Michenfelder-Schauser, Peter Richardson, Andrei Nikolaev, Caitlin Sample, Hengbin Wang, and Rie Fujita, entitled “DESIGN OF LIGAND ATTACHMENT CHEMISTRY FOR HIGH CONDUCTIVITY POLYMER ELECTROLYTES,” (30794.0761-US-P1); which application is incorporated by reference herein.

### BACKGROUND OF THE INVENTION

### 1. Field of the Invention

The present invention relates to compositions of matter useful in battery electrolytes and methods of making the same.

### 2. Description of the Related Art

(Note: This application references a number of different publications as indicated throughout the specification by one or more reference numbers in brackets, e.g., [x], A list of these different publications ordered according to these reference numbers can be found below in the section entitled “References.” Each of these publications is incorporated by reference herein.)

High energy density Li⁺-ion batteries have revolutionized both consumer electronics and electrified transportation [1], However, current Li-ion technology based on organic liquid electrolytes suffers from low chemical, thermal, and mechanical stability, leading to substantial safety concerns [1-3], Ion-conducting polymers form chemically stable, easily processable, and mechanically robust films and could lead to safer and higher performing batteries [2-4], Currently, however, polymer electrolytes lack the ionic conductivity performance required for their use in commercial applications [5], Significant effort has focused on polymers based on poly(ethylene oxide), and while a few polymers have reached ionic conductivities on the order of 10⁻⁴ S cm⁻¹ [6], some studies suggest that the Li⁺ ion only contributes a small fraction of this conductivity (cation transport number, t₊) [7], In fact, both liquid and polymer electrolytes usually transport anions better than cations, with t₊ ranging from −4.5 to 0.2 for standard salt-in-polymer electrolytes [7-10], while some polymer-in-salt polycarbonate electrolytes have pushed t₊ as high as 0.66 [11], This cation entrapment is a result of the specific solvation mechanism of most polymer electrolytes wherein it is challenging to separate the solvation and conduction functions. Thus, finding different polymer classes that enable tuning of polymer-ion interactions for both high ionic conductivity and high t₊ is critical for further advancement in polymer electrolyte performance. The present disclosure satisfies this need.

### SUMMARY OF THE INVENTION

Li-ion rechargeable batteries are the technology of choice for numerous applications, yet the energy density and safety of commercial devices is often limited by using organic liquid electrolytes with high flammability and poor stability of electrode/electrolyte interfaces during operation. Polymer electrolytes promise superior stability and mechanical properties, but are currently limited in ionic conductivity. Expanding polymer design towards the incorporation of functional groups with improved interactions with lithium salts requires a synthetic platform that enables rapid synthesis and ligand screening. A strategic method for the incorporation of ligand functional groups proceeds via thiolene click chemistry. However, within this framework, the attachment chemistry of the functional groups must be designed to eliminate any unwanted ion interactions. Here we disclose design rules for the synthesis of thiol-functionalized ligand moieties with the targeted removal of detrimental functional groups. This invention provides a framework for developing high conductivity polymer electrolytes by focusing on the attachment chemistry for faster segmental motion and improved ion mobility. This invention has resulted in two to four orders of magnitude improvement in ionic conductivity of a model polymer electrolyte system due to both improvements in segmental dynamics as well as changes in ligand-ion interactions.

In one example, the elimination of the amide functional group from the ligand-containing sidechains of ligand-grafted siloxane polymer electrolytes was investigated. The removal of the amide functional group was motivated through the expectation of lower polymer T_{g} through the removal of the hydrogen bonding site. EIS (Electrochemical Impedance Spectroscopy) measurements were carried out for the temperature range between 30-90° C. It showed that the significantly lower T_{g} of the resulting polymer (−44° C.) than the amide-containing polymer (−8° C.), led to about two order of magnitude improved room temperature conductivity. Interestingly, when the conductivity data is normalized by this change in T_{g}, we still see an enhancement of the conductivity of the amide-free version. This indicates that the ionic conductivity decreases further than what would be expected from solely a T_{g} effect, suggesting that the amide group, in addition to hydrogen bonding, also participates in coordination to the Li⁺ or TFSI⁻. This significant discovery suggests an important strategy for the design of ligand attachment chemistry to low-T_{g} polymer backbones, namely the removal of all functional groups or ion binding heteroatoms other than the ligand group of interest within the polymer sidechain. This ensures only the ligand moiety optimized for Li⁺ conductivity will interact with the dissolved salt ions, leading to an improvement in ionic conductivity.

The present disclosure further investigates the effect of adjusting polymer side chain grafting density to determine the optimal performance in imidazole concentration, T_{g} and conductivity. Importantly, while the imidazole solvates the Li⁺ ions, the bulkiness of these functional groups also increase the T_{g}. As a result, we find that an optimum number of imidazole functionalities will lead to optimized conductivity. We have synthesized a library of siloxane polymers with varying imidazole (Im) incorporation using a “grafting to” technique (with imidazole-amide functional groups in the side chain, but the conclusion is applicable to amide-free systems). The extra vinyl groups in the PVMS backbone polymer are functionalized with either a phenyl thiol (Phc) or an ethane thiol unit (Et). A polymer fully functionalized with imidazole is compared to a set of polymers with lower imidazole functionalization. In the first case, we have functionalized the remaining vinyl groups with ethane thiols, while in the second case we used phenyl functional groups to mimic the sterics of the imidazole group without interacting with the Li salt. It is possible to both identify the role of imidazole concentration, as well as the role of steric bulk of the additional grafting moiety on T_{g} and conductivity.

The findings described herein relating to optimization of grafting density may also be applied to other ligand moieties as described herein. Improving Li⁺ ion conduction in polymeric solid electrolytes requires increasing the Li⁺ ion concentration, which requires controlling salt dissociation, and ion mobility. Since cations (Li⁺) are the species of interest for conduction but are typically more solvated by the polymer than anions (e.g., TFSI⁻) and therefore interact more strongly with the polymer matrix, there is a tradeoff between salt dissolution and cation mobility. In the polymers of interest, Li⁺ diffusion occurs via successive ion hops from a solvation site on the polymer sidechain to a nearby open solvation site. The rate of diffusion depends on the proximity of the solvation sites (thus on the segmental dynamics of the polymer, quantified by the glass transition temperature, T_{g}) and on the binding strength of the solvation site to Li⁺. So careful selection of the ligand moieties is needed, as a strong trade-off exists between good solvation resulting in effective salt dissolution and strong cation-polymer binding, leading to lower cation conductivity and transport number. We conducted extensive investigation on the effect of ligand geometry (ligand size and bulkiness, steric effect) and ligand strength (binding affinity, electronic effect) on ion conductivity, identified ligand design rules and high-performance ligands.

In summary, we developed a versatile materials platform for high ionic conductivity and transport number (t₊) polymer electrolytes. Key design elements for the material system development includes: 1. Ligand design for optimized ion solvation and mobility; 2. Linker (spacer) optimization to remove detrimental groups and optimize segmental dynamics; 3. Backbone selection for low system glass transition temperature (T_{g}) and high segmental dynamics; 4. Grafting density optimization to minimize system T_{g} with optimized ligand density; 5. Additives to further boost ionic conductivity and transport number.

Illustrative, non-exclusive examples of inventive subject matter according to the present disclosure are described in the following examples.

1. A polymer, comprising:

a plurality of repeat units, each of the repeat units including a backbone section; and

a plurality of side chains, each of the side-chains attached to a different one of the backbone sections, wherein:

at least some of the side chains include a spacer connected to a ligand moiety, the ligand moiety capable of interacting or bonding (e.g., ionically bonding) to a cation, e.g., so as to at least solvate or conduct the cation,

the spacer comprises moieties that do not (e.g., ionically) bond with the cation (e.g., the spacer consists or consists essentially of one or more non-polar moieties, one or more non-polar functional groups), and

the spacer is at least 4 atoms long, or has a length in a range of 4-20 atoms (chain of 4 4≤N≤20 atoms).

2. The polymer of example 1, wherein the glass transition temperature is less than 40 degrees Celsius or less than 50 degrees Celsius.

3. The polymer of example 1, wherein the polymer has a glass transition temperature of 0 degrees Celsius or less than 0 degrees Celsius.

4. The polymer of example 1, wherein the polymer has a glass transition temperature of less than minus twenty degrees Celsius.

5. The polymer of example 1, wherein the spacer consists essentially of at least one of carbon, sulfur, silicon phosphorus, or hydrogen.

6. The polymer of any of examples 1-4, wherein the spacer does not include nitrogen or oxygen.

7. The polymer of any of the examples 1-5, wherein the spacer comprises or consists essentially of an aliphatic chain, alkane, an ether, a siloxane, or a thiol ether.

8. The polymer of any of the examples 1-6, wherein the ligand moiety comprises an electron rich group or a group comprising an electron lone pair.

9. The composition of matter of any of the examples 1-8, wherein the spacer does not include an amide.

10. The polymer of any of the examples 1-9, wherein the ligand moiety comprises an imidazole or cyano.

11. The polymer of any of the examples 1-10 having one of the following structures:

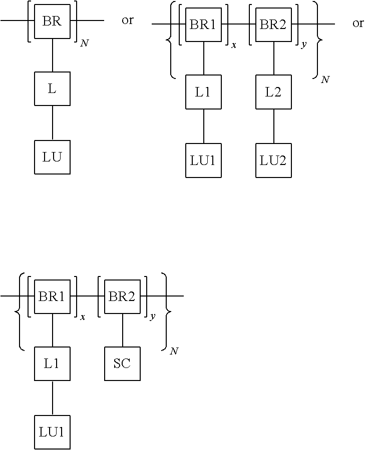

wherein BR, BR1, BR2 comprise the backbone section, L1 and SC comprise the spacer, and LU, LU1, LU2 comprise the ligand moiety.

12. The polymer of any of the examples 1-11, wherein the ligand moiety comprises at least one group selected from:

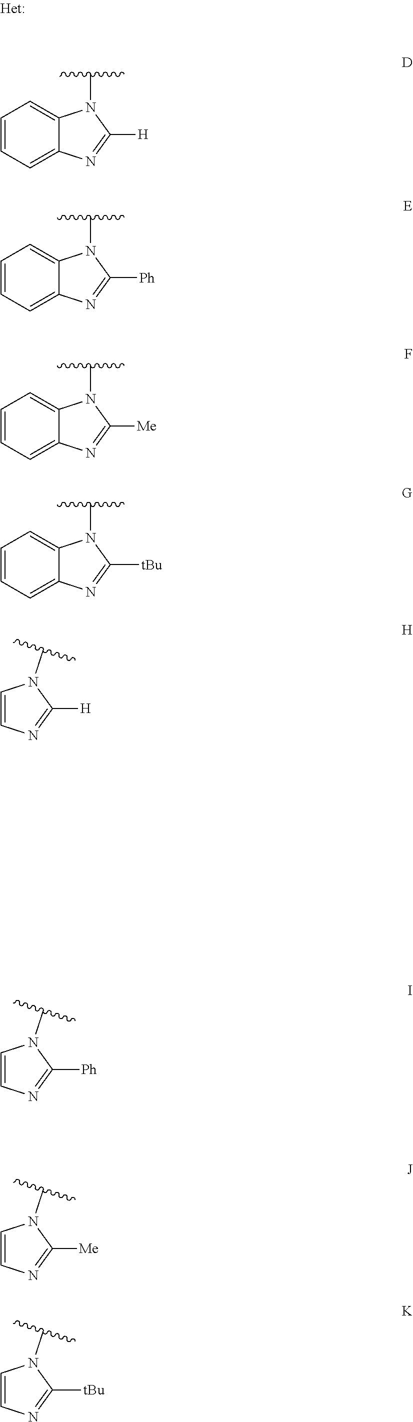

13. The polymer of any of the examples 1-11, wherein the ligand moiety comprises at least one group selected from:

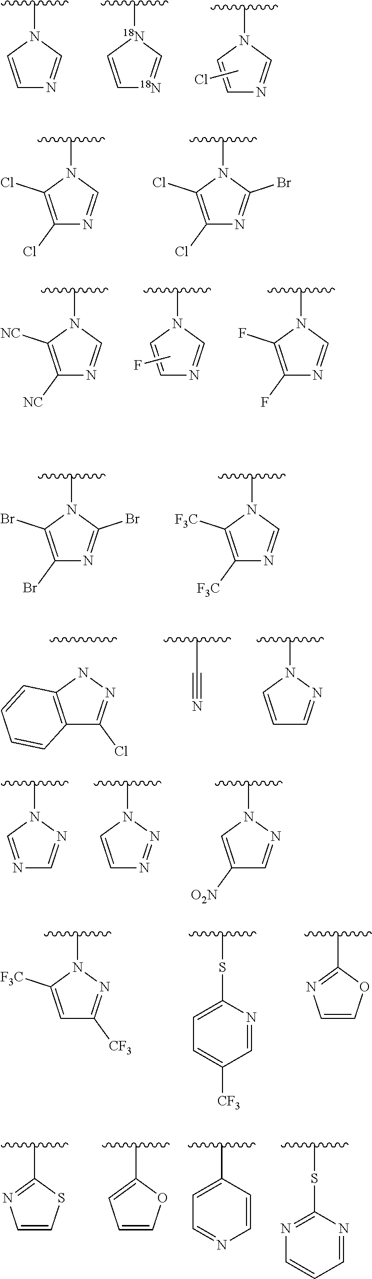

14. The polymer of any of the preceding examples, wherein the ligand moiety is grafted onto the backbone with a grafting density of 100% or less than 100%.

15. The polymer of any of the preceding examples, wherein the polymer has the ligand moiety content such that the Li⁺ to ligand moiety molar ratio MR is in a range of 0.03≤MR≤0.6, 0.07≤MR≤0.6, and 0.3≤MR≤0.4.

16. The polymer of any of the preceding examples, wherein the polymer has the ligand moiety such that the glass transition temperature is below 40 degrees Celsius and the polymer has the conductivity for the cation, comprising a lithium ion, of at least 10⁻⁵ cm⁻¹ (e.g., at the temperature of 30 degrees Celsius).

17. The polymer of any of the preceding examples, wherein the backbone section comprises one of the following:

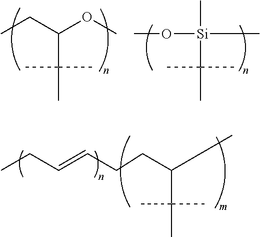

and n and m are integers in a range of 5-5000.

18. A polymer comprising the structure:

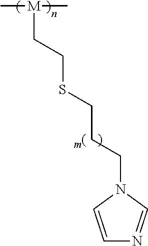

where m and n are integers, M is a monomer unit and S is Sulfur, Silicon or Carbon.

19. A polymer comprising a structure:

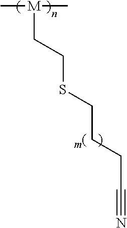

where m and n are integers, M is a monomer unit, and S is Sulfur, Silicon or Carbon.

20. The polymer of example 18 or 19, wherein m is in the range 5-15, 5-25 or such that the spacer has a length in a range of 4-20 atoms, or m can be in a range 0-15, which gives the whole linker or spacer having a length in a range 5-20 atoms.

19. The polymer of any of the examples, wherein the grafting density GD of the sidechains is 50%≤GD≤90%, 50%≤GD≤100%, 50%≤GD≤99%, 60%≤GD≤80%, 80%≤GD≤100%, 80%≤GD≤90%, 80%≤GD≤99%, 75%≤GD≤90%, or a combination thereof.

tailored for a conductivity of a Lithium ion in an electrolyte comprising the polymer.

21. The polymer of any of the examples, wherein not all the sidechains comprise the ligand moiety.

22. The polymer of any of the preceding examples, wherein the polymer comprises a bottlebrush polymer.

23. An electrolyte comprising the polymer of any of the preceding examples, wherein the cation is Li⁺.

24. The electrolyte of example 23, further comprising an additive for increasing the conductivity of the cation in the electrolyte.

25. A battery comprising the electrolyte of examples 23 or 24 in contact with an anode and a cathode.

26. The battery of example 25, wherein the polymer has the ligand moiety configured for solvating and conducting the cation comprising lithium ions in the electrolyte and having a glass transition temperature such that the polymer is in a solid state during operation of the lithium ion battery with the electrolyte comprising the polymer.

27. A method of making an electrolyte in a lithium ion battery comprising:

providing a polymer having a ligand moiety configured for solvating and conducting lithium ions in the electrolyte and having a glass transition temperature such that the polymer is in a solid state during operation of the lithium ion battery with the electrolyte comprising the polymer.

28. The method of example 27, further comprising controlling a grafting density or content of the ligand moiety so that the conductivity is at least 10⁻⁵ S cm⁻¹ at 30 degrees Celsius and the glass transition temperature is below 40 degrees Celsius.

29. The method of examples 27 or 28, further comprising using nuclear magnetic resonance to obtain a measurement of the solvation and the conductivity of the lithium ion as a function of the ligand moiety, and using the measurement to select the ligand moiety used in the electrolyte.

30. A method of making a composition of matter, comprising:

(a) combining at least one of an imidazole, pyrazole, triazole, pyridine, oxazole, thiazole, furan, nitrile, or pyrimidine, with an alkane to form a derivative;

(b) combining sulfur with the derivative to form a thiol; and

(c) combining the thiol with a polymer comprising a siloxane to form the polymer comprising a side chain including the thiol.

31. The method of example 30, wherein the combining (c) comprises a thiol-ene click reaction.

32. The method or composition of matter of any of the preceding examples, wherein the ligand moiety comprises at least one of nitrogen, oxygen, sulfur, or phosphorous.

33. The method or composition of matter of any of the preceding examples, wherein the ligand moiety comprises at least one compound selected from an amine, a cyano, a pyrrolidine, a pyrroline, a pyrrole, an imidazole, a pyrazole, a piperidine, a tetrahydropyridine, a pyridine, a pyrimidine, a pyrazine, a pyridazine, a naphthyridine, an azaindole, a substituted imidazole as listed in FIG. 6, a halogenated imidazole (2, or 4-fluoroimidazole, 2, or 4-chloroimidazole, 2, or 4-bromoimidazole, 2, or 4-iodoimidazole, bis or tris-fluoroimidazole, bis or tris-chloroimidazole), a tetrahydrofuran, a furan, an oxazole, an isoxazole, and a 1,2-, or 1,3-, or 1,4-dioxane.

34. The method or composition of matter of any of the preceding examples, wherein the cation comprises Li⁺.

35. A composition of matter or polymer manufactured using the method of any of the examples 30-34.

36. A composition of matter comprising the polymer of any of the examples.

### BRIEF DESCRIPTION OF THE DRAWINGS

Referring now to the drawings in which like reference numbers represent corresponding parts throughout:

FIG. 1A. Schematic of the molecular model for the metal salt-coordinating polymer. The backbone monomeric species is shown as red, and the imidazole side chain block is shown as blue, with polarizability volumes α_{A} and α_{B}, respectively.

FIG. 1B. Polymers with sidechains containing an imidazole ligand grafted using thiol-ene click chemistry. Structure comparison between the amide-free (PMS-10-Im) and the amide-containing (PMS-6-Amide-3-Im) polymers. Both polymers are based on a low T_{g} siloxane backbone with sidechains containing an imidazole ligand grafted using thiol-ene click chemistry, but differ in their linker structure. The removal of detrimental functional groups (structure A, no amide) provides improved conductivity over structure B (with amide).

FIG. 1C. Scheme 2 Synthesis Method for PMS-10-Im and PMS-6-Amide-3-Im.

FIG. 2. Ionic conductivity as a function of temperature, showing about 2 orders of magnitude change in room-temperature conductivity associated with the presence or absence of the amide functional group.

FIG. 3. T_{g}-normalized ionic conductivity still shows over a magnitude improvement in the conductivity through the removal of the amide functional group, suggesting that the conductivity increase is not solely governed by T_{g} effects.

FIG. 4. T₁ₚ decay curve measured at 55.2° C. for amide-free polymer requires a two-component fit, highlighting the existence of at least two Li environments. Temperature dependence of component 1 contribution is shown in the inset.

FIG. 5. Conductivity and T_{g} behavior of high salt concentration PMS-6-Amide-3-Im polymer electrolytes.

FIG. 6. Further examples of imidazole derivative, pyrazole derivative and nitrile derivative (also called cyano) containing polymer sidechains.

FIG. 7. Further examples of imidazole derivatives, and synthesis method for the examples of FIG. 6, FIG. 7 FIG. 8.

FIG. 8. Further examples of nitrogen and oxygen containing heterocycle side chains.

FIG. 9A-9F. Ionic conductivities of some of the polymer electrolyte examples in FIGS. 6 and 8.

FIG. 10. WAXS profiles of some of the polymer electrolyte examples in FIGS. 6 and 8.

FIG. 11. Diffusion constants measured at 81.4° C. for the various ligands of interest at r=0.3 in LiTFSI salt. Inset shows an enlarged region to highlight differences between ligand identities.

FIGS. 12A and 12B. Transport numbers obtained at 81.4° C. for the various ligands of interest at r=0.3 in LiTFSI salt.

FIG. 13. Lithium transport number as a function of temperature for the PMS-9-CN polymer at r=0.3 in LiTFSI salt.

FIG. 14. Example polymer backbone structures (PAGE, PVMS and PBD).

FIG. 15A Schematic of the study to identify the optimal grafting density of imidazole functional units; one set of polymers will have a constant steric bulk by replacing the imidazole with another large side chain but with non-ion interacting end units. Series 1 changes the imidazole grafting density by replacing imidazole with a non-bulky ethane spacer, while Series 2 replaces the imidazole with a phenyl spacer to maintain similar steric bulk.

FIG. 15B. The chemistry of the polymers that were synthesized, using an imidazole-amide side chain interspersed with ethane or phenyl-carbon side chains (Scheme 3).

FIGS. 16A-16B: WAXS data for the (FIG. 16A) ethane-imidazole and (FIG. 16B) phenyl-imidazole polymer series. Without salt shows additional structure arising in the ethane-imidazole system through the appearance of a shoulder peak around 0.8 nm to 1.2 nm which grows in intensity and shifts to larger d-spacing as the imidazole content decreases. Such additional structure is not present for the phenyl-imidazole series.

FIGS. 17A-17C: SAXS shows change in aggregation peak location and intensity with (FIG. 17A) salt concentration in the ethane-imidazole polymer containing 7% imidazole, and with imidazole grafting density at a constant Li+ to monomer molar ratio of 0.1 for the (FIG. 17B) ethane-imidazole and (FIG. 17C) phenyl-imidazole polymer series.

FIGS. 18A-18B: Polymer glass transition temperature (T_{g}) versus grafting density for the ethane-imidazole (FIG. 18A) and phenyl-imidazole polymer (FIG. 18B) grafting series. A lower imidazole content results in lower T_{g} due to the removal of the polar and hydrogen-bonding groups. The lower steric bulk of the ethane spacer unit results in a lower T_{g} (−90° C. than the fully phenyl-functionalized polymer (−68° C.). A very low T_{g} as expected for siloxane backbone polymers is recovered when no imidazole is incorporated into the polymer, suggesting the imidazole side chain is responsible for a dramatic increase in T_{g}. The use of ethane spacers effectively decreases the glass transition temperature of the polymers ranging from −8° C. (full imidazole functionalization) to −90° C. for full ethane functionalization. The T_{g} also decreases upon reducing imidazole content in the phenyl-imidazole polymer series; while the extent of T_{g} decrease is smaller than the ethane-functionalized PVMS, decreasing to −70° C. upon full phenyl functionalization, the T_{g} of the resulting polymer is still much lower than the imidazole-amide functionalized polymer. This follows from the removal of the amide functionality in the phenyl side chain, reducing the extent of hydrogen bonding as the imidazole-amide content is lowered.

FIG. 19A-19B: Total ionic conductivity for the (FIG. 19A) ethane-imidazole and (FIG. 19B) phenyl-imidazole series as a function of the percentage of monomers containing an imidazole sidechain. Conductivity increases with lower imidazole content until all imidazole is removed for the ethane-imidazole mixed grafting polymers. An increase in conductivity (measured at 30° C.) is observed as the imidazole content is reduced; thus far, an increase in conductivity of about an order of magnitude was measured for the ethane-imidazole series at 7% and 20% imidazole incorporation compared to 100% imidazole incorporation. At 100% ethane functionalization the conductivity drops again, since the resulting thioether group is inefficient at dissolving and conducting LiTFSI salt. Conductivity increases then decreases with decreasing imidazole content for the phenyl-imidazole polymer library. This is likely due to the increased separation of the imidazole groups by bulky phenyl side chains (the extra bulk of the phenyl spacer ultimately results in poorer conductivity performance at low imidazole grafting density, likely due to the higher glass transition temperature and increased separation between imidazole groups). The conductivity of the fully phenyl-carbon functionalized polymer was not measurable, which indicates that the phenyl group alone does not participate in ion solvation or conduction.

FIG. 20A. T_{g}-normalized total ion conductivity versus grafting density for the ethane imidazole and phenyl-imidazole polymer series at a Li⁺:monomer ratio of 0.1.

FIG. 20B. The T_{g}-normalized conductivity can be approximately normalized by salt concentration (to obtain molar conductivity) and plotted against the mmol of imidazole per gram polymer which acts as a proxy for imidazole molar volume. This data now shows a very similar trend between the ethane and phenyl series. Error bars are smaller than symbols.

FIG. 21 plots the transport numbers, total EIS-measured ionic conductivity and adjusted Li+-ion conductivity for the three PVMS-Et-Im grafting density polymers measured using PFGNMR at 72.7° C. All samples consist of a 0.1 Li:monomer ratio of LiTFSI added to the polymer. The green diamonds are conductivity from EIS. The blue squares are Li+ transport numbers. The orange circles are the Li+ conductivity, which is a fraction of the total conductivity (total conductivity times transport number).

FIGS. 22A-22B. Ionic conductivity as a function of temperature, for varying weight percentages of (FIG. 22A) PEG (400) or (FIG. 22B) 1-ethyl-3-methylimidazolium TFSI added to PMS-6-Amide-3-Im and LiTFSI salt mixture (keeping a 1.5 Li:monomer ratio throughout). Data points for the un-plasticized sample were extrapolated from data obtained on two lower and higher salt concentrations.

FIGS. 23A-23C illustrate example polymer structures according to embodiments described herein.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

Technical Description

Metal-ligand coordination polymers enable tunable dynamic interactions between cations and ligands tethered to a polymer backbone [12-15] and promote salt dissolution even with low polarity polymer backbones, [16] providing a large library of polymers for optimizing conductivity performance [10,16,17], Ion conduction in polymer electrolytes is achieved through the dissolution of a metallic salt and subsequent transport of the metal cation and organic anion [18-20], Polymer electrolytes must therefore contain solvating groups that interact with ions (typically the cation) to stabilize ionic species but still allow for ion mobility [10,11,21], The careful choice of the solvating group is warranted, as a strong trade-off exists between good solvation resulting in effective salt dissolution and strong cation-polymer binding, leading to low t₊. We have demonstrated the dynamic metal-ligand coordination of imidazole-containing polymers toward lithium and other metal ions, suggesting this class of materials satisfies these requirements [10,16,17].

More specifically, increased Li-ion conductivity of polymer electrolytes at room temperature can be achieved by increasing both ion concentration, which requires controlling salt dissociation, and ion mobility. Ion concentration is governed by equilibrium salt dissociation, which occurs via the following equilibrium steps:

MX₂ [symbol] M⁺+zX⁻

M⁺+qL [symbol] (ML_{q})⁺

where M is the cation of interest (Li⁺), X is the anion, L is the ligand species, q is the coordination number, κ is the equilibrium constant for salt dissociation, which depends on the dielectric environment of the matrix in which the salt dissociates, and β is the equilibrium constant for cation coordination with ligand species within the polymer. In one or more examples, increased ion concentration is achieved through a large κ, which can be tuned through the choice of counterion as well as by the polymer dielectric environment. Increasing ion mobility may involve improving the frequency of ion exchange between coordination sites in a polymer matrix, which is tuned through the choice of ligand species.

In one or more examples, a desirable composition of matter may comprise a system for which ion-polymer interactions are labile, the system remains amorphous (the salt or polymer do not crystallize) and solvation structure enables percolated networks for ion transport. The lability of metal-polymer interactions can be tuned by using different coordinating groups whose geometry or strength of interaction may increase the kinetics of ligand exchange. In one or more examples, variations on imidazole ligands with electron-withdrawing or bulky groups may increase ligand exchange rates. Further, weaker ligand chemistries including carbonyl and nitrile groups may also be used. Adding steric interference or electron withdrawing groups to the imidazole ligand may also further increase the kinetics of metal-ligand exchange. Some low T_{g} polymers are listed in page 1 of the Appendix D such as polysiloxane, polyether, MEEP (poly[bis((methoxyethoxy)ethoxy)phosphazene], and acrylonitrile-co-butylacrylate.

### First Example: Amide Free Imidazole Containing Side-Chains

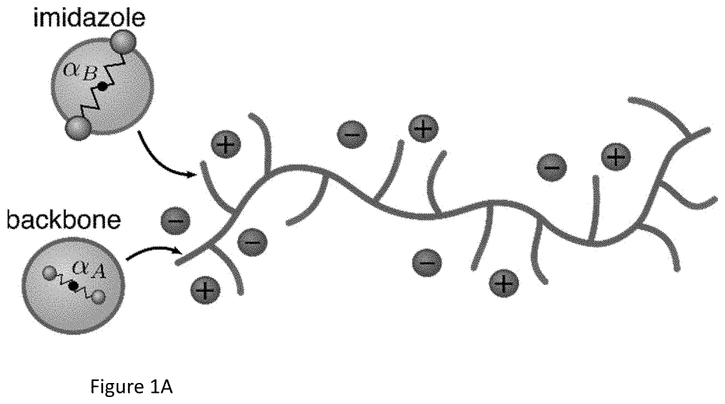

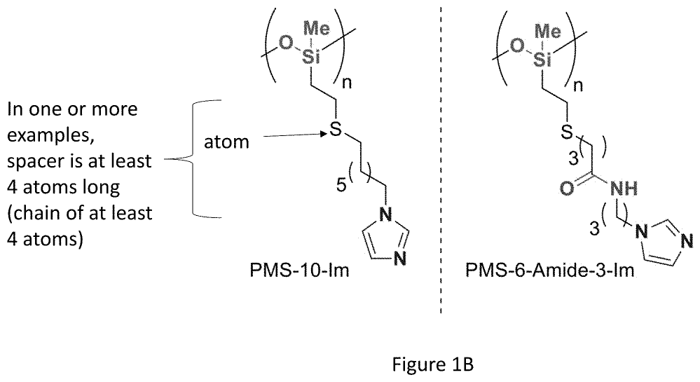

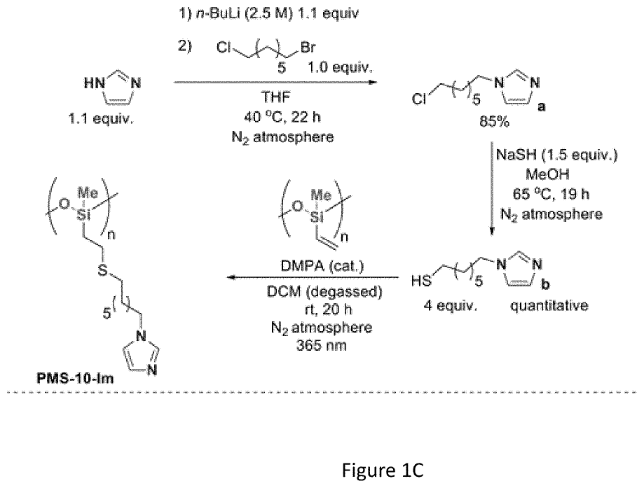

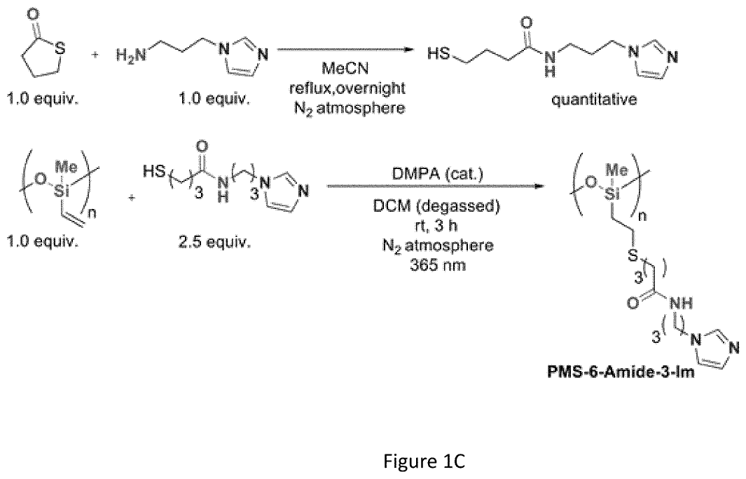

In this example, we show how rational polymer design can result in dramatic improvements in both total ionic conduction and Li⁺ t₊. We functionalize a low T_{g} siloxane polymer backbone with an imidazole-based ligand, but change the linker identity from an amide-containing linker (forming PMS-6-Amide-3-Im) to an aliphatic chain (forming PMS-10-Im, FIGS. 1A-1B). This improves room temperature ionic conductivity by 2 orders of magnitude and Li⁺ t₊ by a factor of 2 due to the removal of the hydrogen bonding and Li⁺-coordinating amide group. This work highlights the role of both intended and unintended ion binding sites within a polymer in controlling both T_{g} and ion mobility.

The PMS-10-Im polymer was designed to reduce polymer T_{g} and eliminate unwanted ion-polymer interactions through the removal of unnecessary polar functional groups. The ionic conductivity of most polymer electrolytes is governed by Vogel-Fulcher-Tamman temperature dependence, where free volume and segmental dynamics (as measured by the glass transition temperature, T_{g}) strongly affect ion mobility [22-24]. Thus, low T_{g} polymer electrolytes are favorable for higher conductivity performance. We have shown that backbone polarity is unimportant for ion conductivity performance, emphasizing that backbone choice should focus on T_{g} rather than polarity [16], Therefore, poly(methylsiloxane) was chosen for this study because it is noncoordinating and possesses low T_{g} [6,16], While the siloxane backbone itself shows low T_{g}, the T_{g} increases by over 100° C. upon functionalization with the first-generation imidazole ligand [16], we hypothesize that the hydrogen-bonding capability of the amide functional group might be one of the factors contributing substantially to this increase.

To construct an amide-free imidazole-containing polymer a modular synthetic approach was developed (Scheme 1).

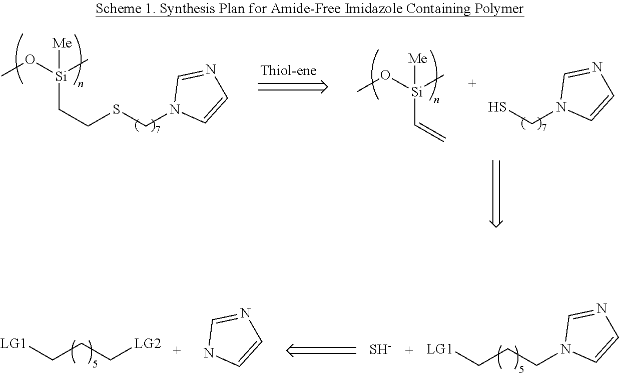

Attaching an amide-free imidazole-containing side chain onto the poly(methylsiloxane) backbone can be readily accomplished using an alkene hydrothiolation reaction (thiol-ene) between poly(vinylmethylsiloxane) (PVMS) and a thiol-alkyl-imidazole [17], The synthesis of a thiol-alkyl-imidazole side chain can be achieved through sequential substitution reactions. Using an alkyl chain bearing a leaving group (LG1 and LG2 in Scheme 1) at each terminal carbon allows for two sequential substitution reactions, first with an imidazole and then with an SH⁻ source.

The amide-free imidazole-grafted siloxane polymer (PMS-10-Im) was compared to the previously reported amide-containing version (PMS-6-Amide-3-Im) to identify whether the amide group enhanced or decreased Li⁺-ion transport. The two-step synthesis of PMS-6-Amide-3-Im polymer started with an addition reaction between γ-thiobutyrolactone and 1-(3-aminopropyl)imidazole to yield the corresponding thiol-containing product. In the next step, this thiol-containing side chain was readily introduced onto PVMS through hydrothiolation reaction under continuous irradiation with 365 nm light. The three-step synthesis of PMS-10-Im began with a substitution reaction between 1-lithio-1H-imidazole (generated in situ from imidazole and n-BuLi) and 1-bromo-7-chloroheptane to yield the corresponding product a (Scheme 2). In the second step, a substitution reaction between a and sodium hydrogen sulfide (NaSH) leads to the corresponding thiol product b (Scheme 2, FIG. 1C). Utilizing light-driven hydrothiolation reaction between thiol b and PVMS allows access to the amide-free imidazole-containing target polymer PMS-10-Im (Scheme 2). The successful synthesis of an amide-free imidazole grafted polymer resulted in a decrease in polymer T_{g} from −8 to −44° C. (Table S2 in [25]), suggesting the amide was indeed detrimentally increasing T_{g}.

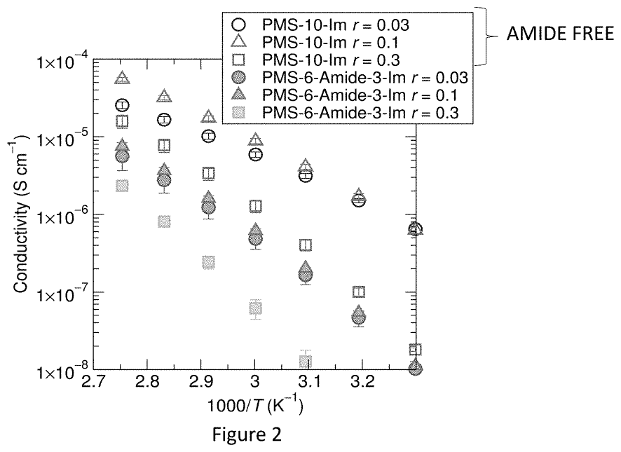

The total ionic conductivity performance of these two polymers mixed with lithium bis(trifluoromethanesulfonyl)imide (LiTFSI) salt was compared using impedance spectroscopy. FIG. 2 shows a 56-63× improvement in the ionic conductivity of the amide-free polymer electrolyte at room temperature, with the improvement decreasing to just over half an order of magnitude at 90° C., slightly dependent on salt concentration (see Table S3 in [25]). This is a dramatic increase in conductivity solely driven by the removal of the polar and hydrogen-bonding amide functional group from the side chains of the polymer electrolyte. This confirms the subtle role played by functional groups even when they constitute only a small part of the overall polymer chemistry and suggests paths to enhance the total conductivity performance.

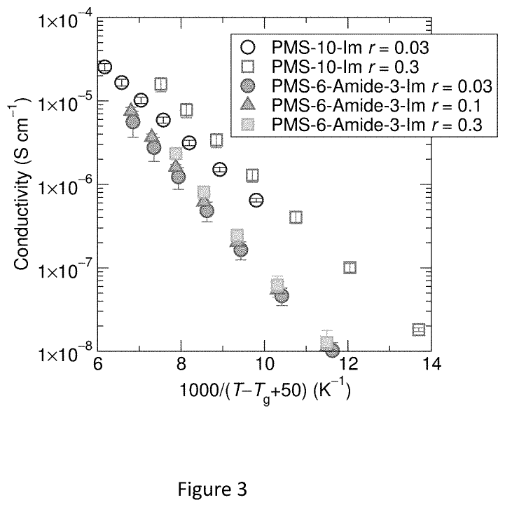

The curved nature of the conductivity data plotted in an Arrhenius fashion suggests the influence of segmental dynamics on conductivity. To ascertain the extent to which T_{g} plays a role in conductivity improvement, the conductivity data can be normalized by T_{g}. The removal of the amide functional group, PMS-10-Im, still results in a 10-fold increase in conductivity over PMS-6-Amide-3-Im after normalization by the T_{g} of each sample (FIG. 3). Normalization in a T_{g}/T representation is also shown in the SI of [25], revealing similar trends. These T_{g}-normalized representations highlight that T_{g} only accounts for a little less than half of the conductivity improvement of the amide-free polymer. Importantly, this suggests that the amide is also participating in ion solvation and binding.

Total conductivity, as measured using impedance spectroscopy does not provide information on which ions contribute to the ionic conductivity. It is, therefore, unclear from these measurements alone whether the amide interacts more strongly with the Li⁺ cation or TFSI⁻ anion. To probe individual ion mobilities in each electrolyte more closely, these polymers were studied further using pulsed-field-gradient (PFG) and NMR relaxometry.

TABLE 1
Li⁺ (D₊) and TFSI⁻ (D₋) Self-Diffusion Constants, Li⁺
Transport Numbers, and Calculated Conductivity Arising from
the Li⁺ (σ₊) and TFSI⁻ (σ₋), As Well As the Total
Calculated Conductivity (σₜₒₜₐₗ) and Interpolated Measured Conductivity
as a Function of Temperature for an Amide-Free Polymer
with Li/Monomer = 0.3 (0.1 in S1) and Amide-Containing Polymer
with Li/Monomer = 0.1

| | diffusion constants | | | conductivity | | | |
|---|---|---|---|---|---|---|---|
| temp | (×10 [symbol] m² s⁻¹) | | t⁺ | (×10⁻⁵ S cm⁻¹) | | | |
| (° C.) | D₊ | D₋ | (%) | σ₊ | σ₋ | σₜₒₜₐₗ | σ_{measured} |

amide-free

| | | | | | | | |
|---|---|---|---|---|---|---|---|
| 72.7 | 1.7 | 2.0 | 0.46 | 0.57 | 0.68 | 1.3 | 0.6 |
| 81.4 | 3.1 | 4.2 | 0.42 | 1.0 | 1.4 | 2.4 | 1.2 |

amide-containing

| | | | | | | | |
|---|---|---|---|---|---|---|---|
| 72.7 | 1.0 | 3.3 | 0.23 | 0.11 | 0.34 | 0.44 | 0.2 |
| 81.4 | 1.9 | 6.2 | 0.23 | 0.19 | 0.62 | 0.82 | 0.5 |

[symbol]

indicates data missing or illegible when filed

PFG experiments reveal an increase in the Li⁺ t₊ from 0.23 for the amide-containing polymer to 0.46 for the amide-free polymer at 72.7° C. (Table 1). This arises from a clear increase in the Li⁺ diffusion constant for the amide-free polymer compared to the amide-containing polymer. Interestingly, the amide-free polymer also shows a decrease in TFSI⁻ diffusion, possibly due to increased ion-ion interactions from a higher salt concentration.

Li⁺ t₊ measurements confirm that the amide group slows down the dynamics of the Li⁺ ions, which is consistent with the conductivity data. Unlike the TFSI⁻ ions, the Li⁺ ions are expected to interact with the polymer side chains, specifically with the nitrogen site of the imidazole [10,16] but also, as shown here, with the amide site. Therefore, the observed increase in conductivity through the removal of the amide group can be attributed to a combination of decreased T_{g} and selective enhancement of the Li⁺ dynamics.

PFG NMR also suggests that the fraction of ions not participating in the conduction process is roughly equal for the two polymers. This fraction is determined by comparing the measured conductivity to the conductivity calculated using the self-diffusion constants (D+ and D−) determined from PFG NMR (Table 1, calculations in the SI of [25]). Here, the measured conductivity is about half of that calculated from PFG NMR, which does not account for any neutral pairs or clusters that do not contribute to net charge transport. While it is not possible to determine whether the loss of ions corresponds to the loss of Li⁺, TFSI⁻ ions or a combination of both, since the fraction of ions that do not participate in the conduction process is similar for the two polymers, it is fair to assume that the observed increase in transport number is reliable. The diffusion constants, transport numbers, and calculated conductivity arising from the cation (σ+), anion (σ−), and total calculated and measured conductivities are summarized in Table 1 for both polymers.

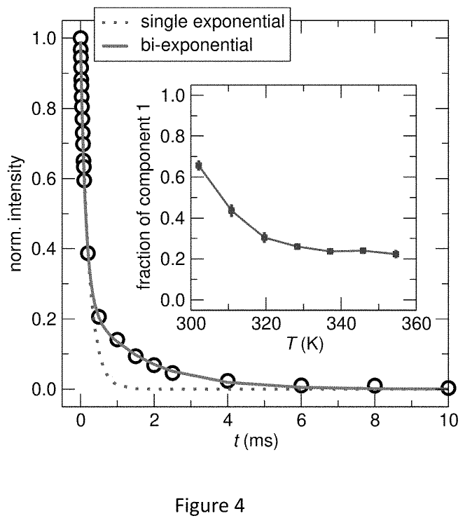

Finally, NMR spin-lattice relaxation time measurements in the rotating frame of reference (T₁ₚ) were used to distinguish between ion environments with significant differences in dynamics. T₁ₚ results reveal at least two distinct Li environments in the two polymers (FIG. 4). Li⁺ ions in the polymer matrix thus exist in faster- and slower-diffusing environments, and the measured D+ self-diffusion constants shown in Table 1 are a weighted average over these two sites. Since these two Li⁺ environments are present in both the amide-free and amide-containing polymers, they may correspond to Li⁺ bound to the imidazole (slower component) and “free” Li⁺ (faster component), yet the exact nature of the “free” Li⁺ cannot be determined from these results. Notably, Tip relaxation measurements enable the determination of not only the Tip for each Li⁺ environment, but also the distribution of Li⁺ species over the two sites. The contribution from component 1 (the faster diffusing of the two sites, determined from the relative activation energies, see SI in [25]) is observed to decrease with increasing temperature (FIG. 4, inset).

The first example shows that the ionic conductivity of polymer electrolytes can be improved by orders of magnitude through rational polymer design. The removal of the hydrogen-bonding and Li⁺-coordinating amide functionality in a metal-ligand coordination polymer enables a 100-fold increase in room-temperature total ionic conductivity and a doubling of the Li⁺ transport number. These results emphasize the large gains that can be made in electrolyte performance through the targeted removal of detrimental functional groups. Further improvements in electrolytes based on metal-ligand coordination can be expected through a careful choice of ligand moiety, as heterocycles offer tunability of their electronic and steric properties that can readily be exploited in structure-function relationship studies in the future.

### Second Example: The Effect of LiTFSI Concentration

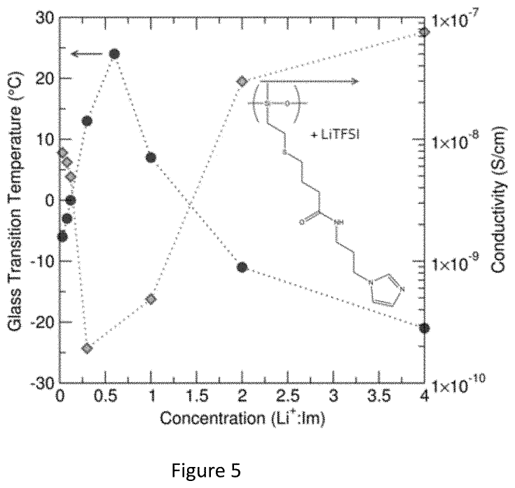

The effect of changing the LiTFSI concentration in the siloxane-backbone polymer fully functionalized with imidazole-amide sidechains (PMS-6-Amide-3-Im) is also investigated. We expected that very high concentrations of salt could lead to another improvement in the ionic conductivity behavior ([6] in Further References section). Up to 78.5 weight percent (wt %) salt was added (see Table 2), and the solubility (through X-ray scattering), glass transition temperature (T_{g}) and conductivity behavior were probed. Only the highest salt concentration of 78.5 wt % showed crystallization of the LiTFSI in the polymer, suggesting that the solubility limit is below 78.5 wt % but above 64.7 wt %. As hypothesized, while an initial decrease in conductivity was observed at intermediate salt concentrations, this was followed by an increase in conductivity for high salt concentrations, with the highest conductivity measured for the 64.7 and 78.5 wt % samples. However, overall the conductivities are still very low and below 10⁻⁷ S/cm, likely because the T_{g} of these polymer electrolytes is unexpectedly high and above −20° C. for all concentrations (Table 2 and FIG. 5).

TABLE 2
Properties of high salt concentration PVMS-Im
(PMS-6-Amide-3-Im) polymer electrolytes.

| | Concentration | T_{g} | Conductivity at |
|---|---|---|---|
| Wt (%) | (Li⁺:Im) | (° C.) | 30° C. (S/cm) |
| 2.67 | 0.03 | −6 | 7.8 × 10⁻⁹ |
| 6.83 | 0.08 | −3 | 6.5 × 10⁻⁹ |
| 9.90 | 0.12 | 0 | 4.9 × 10⁻⁹ |
| 21.56 | 0.3 | 13 | 1.9 × 10⁻¹⁰ |
| 35.47 | 0.6 | 24 | N/A |
| 47.81 | 1.0 | 7 | 4.9 × 10⁻¹⁰ |
| 64.69 | 2.0 | −11 | 3.0 × 10⁻⁸ |
| 78.56 | 4.0 | −21 | 7.6 × 10⁻⁸ |

### Third Example: Additional Side-Chain Examples

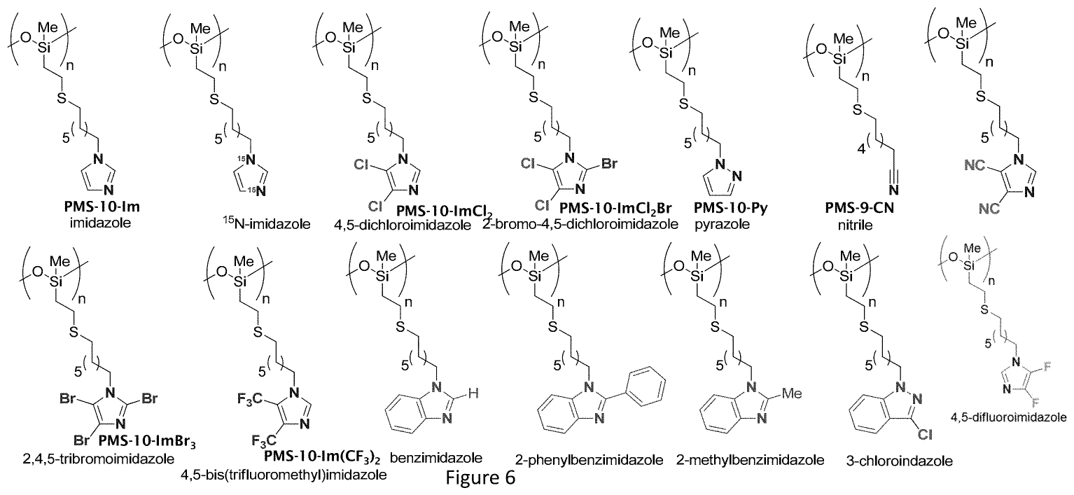

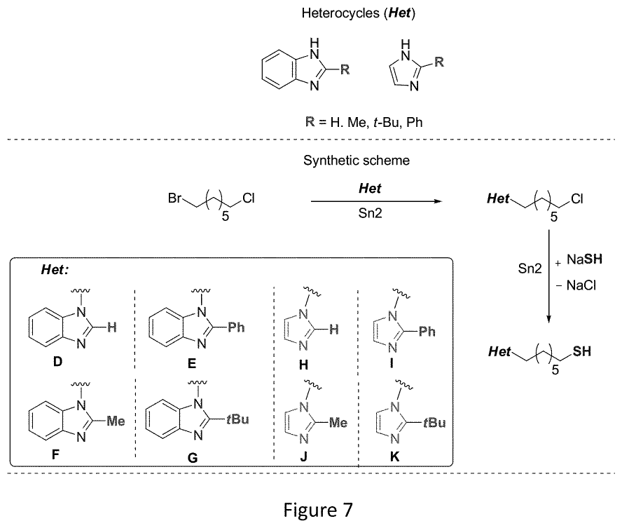

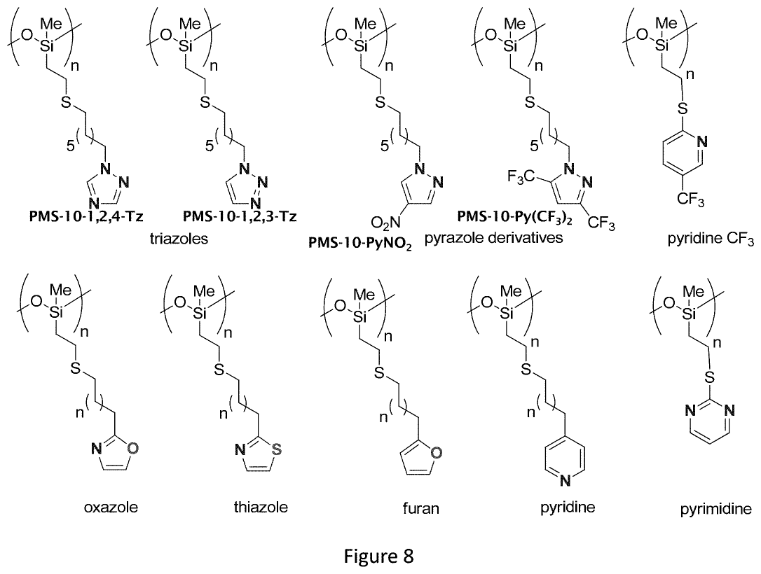

FIG. 6 illustrates a series of strategically-chosen electron-deficient and/or steric bulky ligand-containing polymer electrolytes synthesized using the synthetic approach of FIG. 7. In an extreme case, the nitrogen containing heterocycles is reduced to a simple strong electron-withdrawing, high dielectric constant, ion-coordinating nitrile (cyano) group. FIG. 8 illustrates additional example ligands that can also be manufactured using the method of FIG. 7, including various carbon substituted ligands which remain largely unexplored.

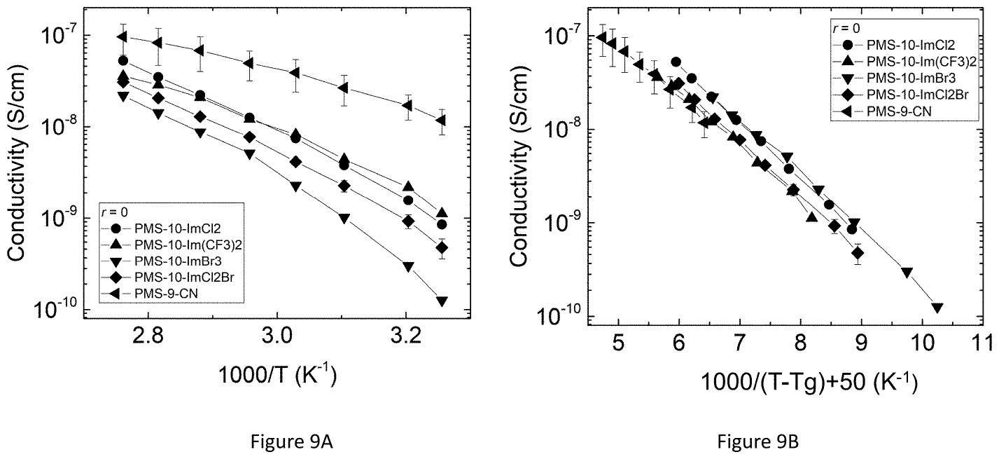

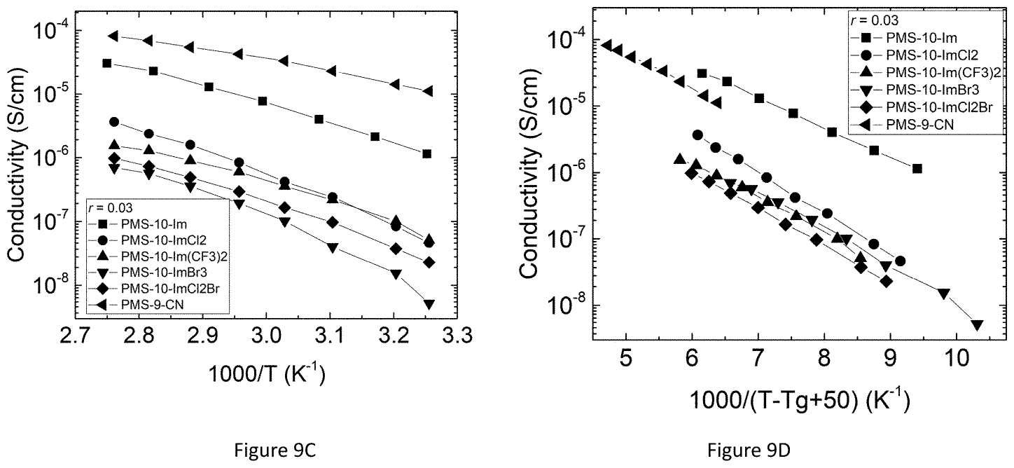

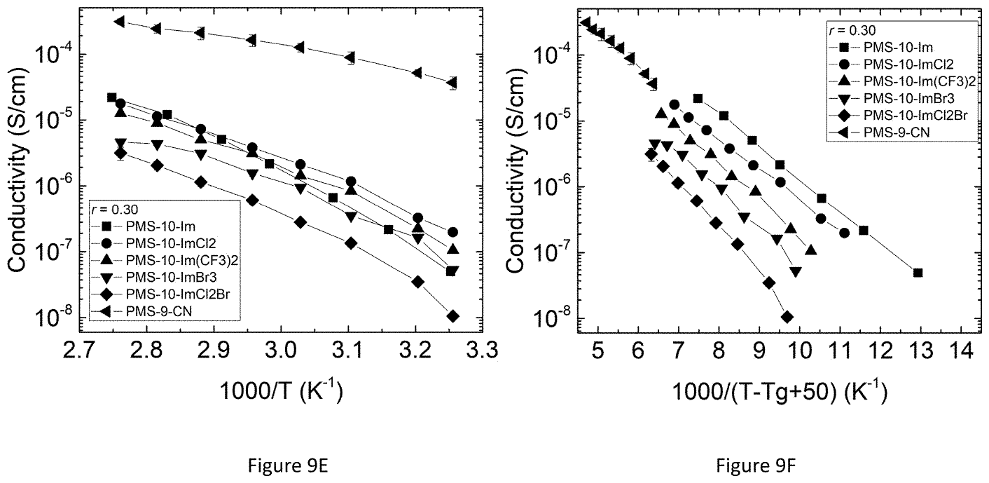

The total ionic conductivity performance of LiTFSI-doped PMS-10-Im, PMS-10-ImCl₂, PMS-10-Im(CF₃)₂, PMS-10-ImBr₃, PMS-10-ImCl₂Br, and PMS-9-CN was extracted from electrochemical impedance spectroscopy (EIS) data (FIGS. 9A-9F). For all of the polymers investigated, conductivity increases with temperature. PMS-9-CN exhibits the highest conductivity at all salt concentrations studied here, namely r=0, 0.03 and 0.30 (salt to ligand mole ratio, also the salt to polymer backbone monomer mole ratio). Moreover, the room temperature conductivity for PMS-9-CN at r=0.30 reaches 3×10⁻⁵ S/cm, which is more than two orders of magnitude higher than any other polymer in this study. Among the polymers with an imidazole-based ligand, PMS-10-Im demonstrates the highest room temperature conductivity of 1.1×10⁻⁶ S/cm at r=0.03, while other polymers have similar conductivity falling in the range of 5×10⁻⁹ to 5×10⁻⁸ S/cm. To understand the influence of ligand structure on ion transport, the Vogel-Fulcher-Tammann (VFT) equation (eq. 1) was applied and the conductivity was normalized by the glass transition temperature (T_{g}) of the polymer/salt mixture to decouple the influence of polymer segmental motion.

σ(T)=σ₀e^{-E}^{ₐ}^{/R(T-T}^{₀}⁾ (1)

In eq. 1, σ₀ is the theoretical conductivity at an infinite temperature, Eₐ is the effective activation energy for ion transport, and T₀ is a reference temperature usually ca. 50° C. lower than the T_{g} of the material. By plotting σ(T) vs. 1/(T−T_{g}+50), we were able to extrapolate the value of Eₐ and σ₀. As shown in FIGS. 9B, 9D, and 9F, the normalized conductivity profiles demonstrate distinct trends. The salt-free polymers have nearly identical slope and γ-intersect, indicating that Eₐ and σ₀ are similar among the five investigated polymers, and the conductivity is mostly controlled by polymer segmental motion. At r=0.03, PMS-10-Im and PMS-9-CN have at least one order of magnitude higher σ₀ than other polymers, while all polymers have similar Eₐ values. At r=0.30, a clearer trend in σ₀ can be identified as PMS-10-Im>PMS-9-CN≈PMS-10-ImCl₂>PMS-10-Im(CF₃)₂>PMS-10-ImBr₃>PMS-10-ImCl₂Br, while Eₐ values for all of these polymers remain mostly identical.

TABLE 3
T_{g} Summary

| | Salt | Tg |
|---|---|---|
| Polymer | Concentration (r) | (° C.) |
| PMS-10-Im | 0 | −44.0 |
| | 0.03 | −22.0 |
| | 0.30 | 7.0 |
| PMS-10-ImCl2 | 0 | −29.1 |
| | 0.03 | −25.3 |
| | 0.30 | −6.0 |
| PMS-10-Im(CF3)2 | 0 | −38.2 |
| | 0.03 | −33.0 |
| | 0.30 | −13.3 |
| PMS-10-ImBr3 | 0 | −13.6 |
| | 0.03 | −13.0 |
| | 0.30 | −17.0 |
| PMS-10-ImCl2Br | 0 | −27.9 |
| | 0.03 | −27.9 |
| | 0.30 | −19.2 |
| PMS-9-CN | 0 | −71.9 |
| | 0.03 | −72.6 |
| | 0.30 | −72.9 |

X-ray scattering (WAXS) and NMR measurements were performed to test our hypothesis that σ₀ is related to the effective ion concentration (excluding charge neutral ion pairs and clusters) while Eₐ is related to the lithium ion-ligand interaction.

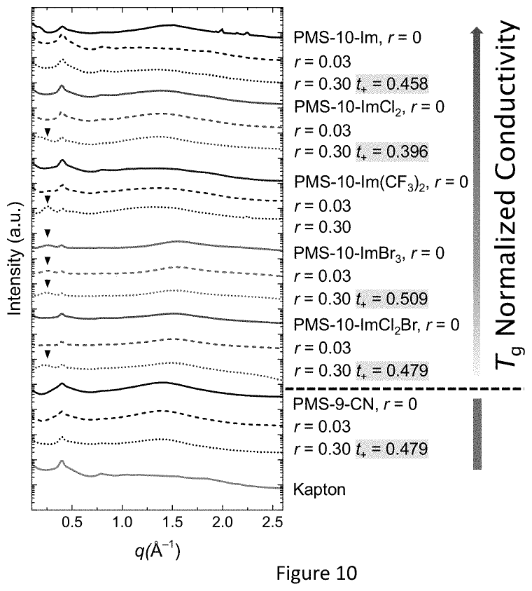

FIG. 10 illustrates wide-angle X-ray scattering (WAXS) profiles for all of the polymers. All samples were sandwiched in an aluminum washer by Kapton films so that a Kapton scattering peak can be seen at ca. 0.4 Å⁻¹. All these polymers and polymer/salt mixtures have no sharp Bragg peaks, indicating that salt ions are well solvated in the matrix without any crystalline structure, and the broad correlation peak at ca. 1.5 Å⁻¹ is from polymer liquid-like packing (amorphous halo). Some salt-doped PMS-10-ImCl₂, PMS-10-Im(CF₃)₂, PMS-10-ImBr₃, and PMS-10-ImCl₂Br show a broad peak around 0.15-0.30 Å⁻¹ (4-2 nm), which might correspond to spacings between domains of high salt density (i.e. salt aggregation). However, PMS-10-ImBr₃ has this feature even without the addition of salt, indicating that the origin of this feature should be investigated in more detail. Note that PMS-10-Im and PMS-9-CN, the two polymer systems showing the highest conductivity at r=0.30 have no such salt aggregation peak, which could be the reason for their high σ₀.

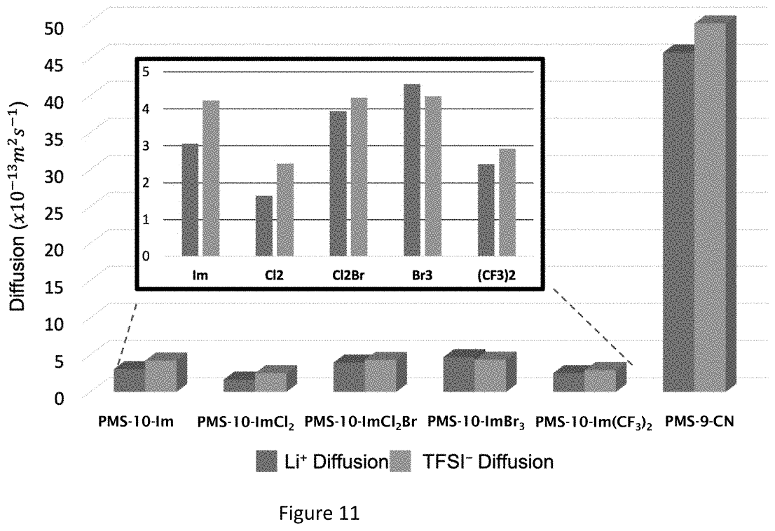

Our results have confirmed that the electron-withdrawing inductive effects play a role in improving lithium transport. Changing the heterocycle from imidazole to 2,4,5-tribromoimidazole improves the lithium transport number from 45.8 to 50.9. We have also shown that the sterics of the heterocycle do not play a significant role, as evident from the lithium transport number decrease going from imidazole to 4,5-dichloroimidazole. If steric effects were a dominant factor, 4,5-dichloroimidazole-containing polymer electrolyte would show higher transference due to weaker interaction with the lithium ion. Also, there clearly is a non-linear trend between the increase in sterics from imidazole to 4,5-dichloroimidazole to 2-bromo-4,5-dichloroimidazole and the Li⁺-transport. From the diffusion values of the Li⁺ (D₊) and TFSI⁻ (D₋) ions in FIG. 11, Li⁺ transport numbers (t₊) can be calculated using eq. 2. The resulting transport numbers are displayed in FIG. 11.

$${t}_{+} = \frac{{D}_{+}}{{D}_{+} + {D}_{-}} \qquad eq . 2$$

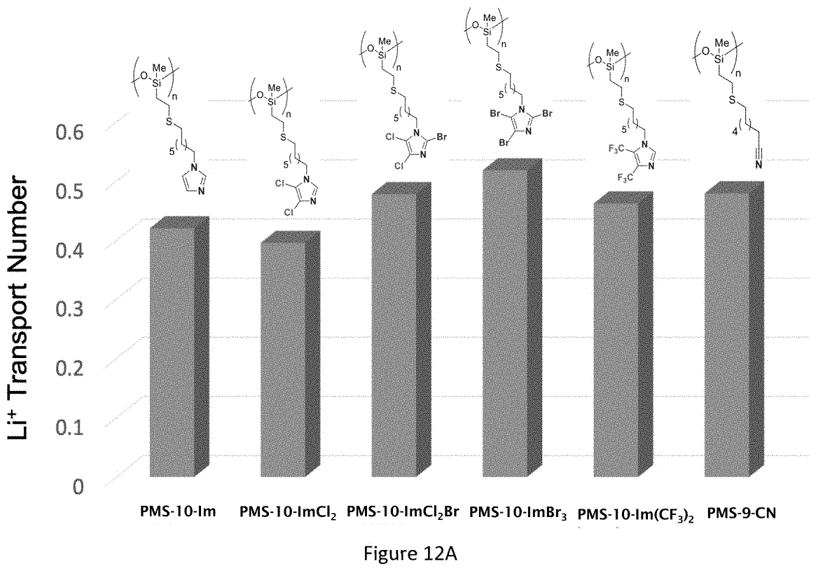

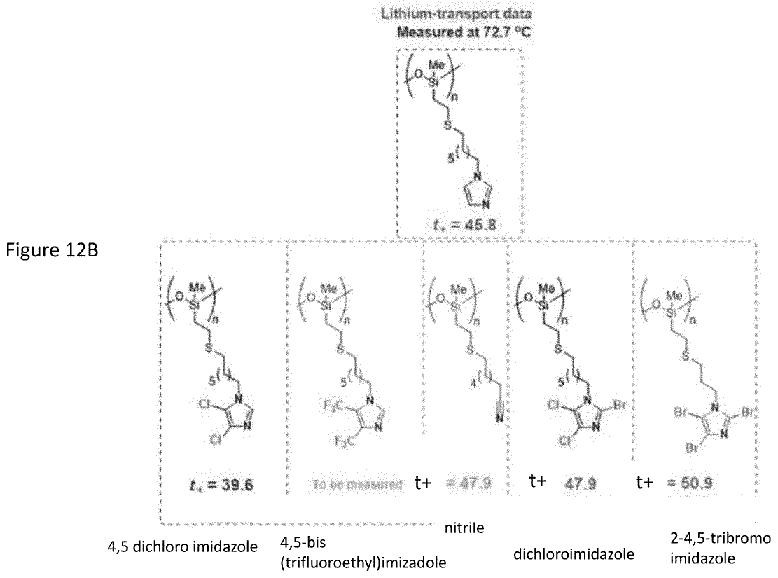

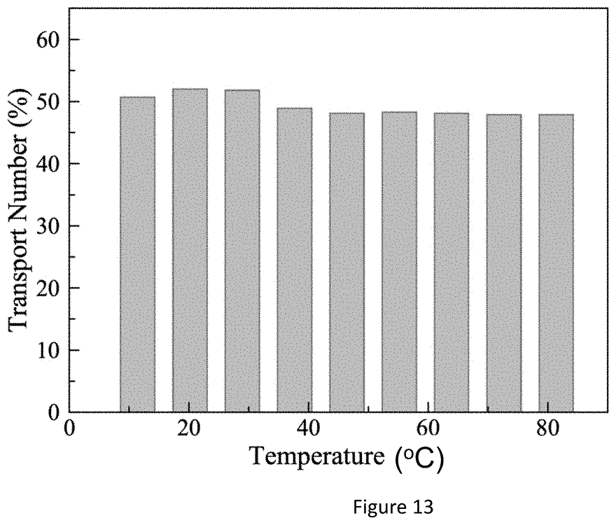

From the data in FIGS. 11 and 12, the ligand with the highest diffusion values, and thus the highest ionic conductivity, is the PMS-9-CN, while the highest transport number was observed for the PMS-10-ImBr₃ ligand. The diffusion constants for Li⁺ (D₊) and TFSI⁻ (D₋) ions in the PMS-9-CN polymer sample are over an order of magnitude larger than for some of the other samples, as highlighted in FIG. 11. The PMS-9-CN polymer sample has sufficiently high diffusion values that we were able to measure D₊ and D₋ values down to 11.4° C. FIG. 13 confirms that the lithium transport number is largely unaffected by a change in temperature, with a slight increase at lower temperatures.

### Fourth Example: Backbone Structures

As described herein, polymer systems inspired by polymeric ionic liquids (PILs) having flexible polymer backbones can be used to conduct lithium ions with tethered ligand moieties that interact dynamically via metal-ligand coordination with transition metal species to form transient cross-linked networks. Backbone identity may have an impact on ion aggregation and thus ionic conductivity for such PIL-inspired systems. Switching from a higher dielectric constant ether-based backbone to one based on poly(butadiene) leads to ion aggregation (observable in X-ray scattering) but unchanged (T_{g} normalized) ionic conductivities, suggesting that aggregation may play a minimal role in conductivity performance. While this initial work focused on flexible backbones and imidazole ligand side-chains, we recognize that improved performance requires a detailed understanding of molecular design to promote salt dissociation and fast transport of the metal cation.

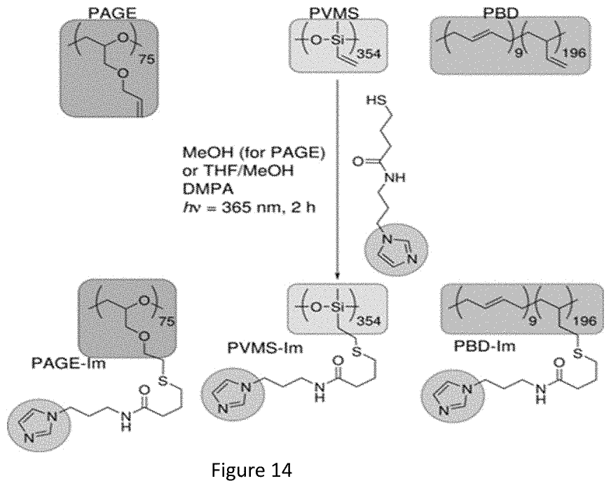

However, the sidechains can be grafted to a wide variety of polymer backbones, as illustrated in FIG. 14.

### Fourth Example: Optimizing Ligand Density for Conductivity in Polymer Electrolytes

Tuning the grafting density of solvating side chains can provide the desired T_{g} control, but also influences the density of solvation sites and extent of ion aggregation within the polymer. A computational study on ether-based electrolytes suggested that the connectivity of solvation sites within an electrolyte can play a critical role in conductivity performance [23,24], Unfortunately, predicting the distribution of solvation sites within a polymer electrolyte can be challenging; experimental methods such as X-ray scattering may observe correlation peaks suggesting some amount of aggregation, but cannot determine the shape of any aggregate features [25], Furthermore, uniformly distributed coordination sites would not show any features in X-ray scattering at all, but may have significantly different connectivity.

Since segmental dynamics play such an important role in determining conductivity behavior, a static view of the solvation site and ion aggregate connectivity in these systems is unwarranted [27], Most electrolyte conductivity is measured significantly above the polymer T_{g}, suggesting local fluctuations are important for aiding in ion transport. Of particular relevance is the timescale for solvation site re-arrangement relative to the timescale for ion motion. The importance of the timescale for solvation site re-arrangement was suggested by Druger, Nitzan and Ratner through the development of a dynamic percolation theory [28-31], This theory has two key timescales—the rate of ion hopping that would be present in a static matrix, and the rate of solvation site re-arrangement. In a system where ion hopping is much faster than solvation site re-arrangement, we recover the static percolation limit, which suggests there is a critical density of solvation sites required to enable ion conduction. However, in the limit where the solvation site re-arrangement is much faster than ion hopping, this percolation threshold disappears entirely, and ion conduction is predicted even for electrolytes with dilute solvation sites. Most electrolyte systems fall intermediate to these two limits, suggesting that both the rate of ion hopping, dictated by ion-solvation site dynamics, and the rate of solvation site re-arrangement, dictated by segmental dynamics, are important for ion transport [23], Indeed, this explains why T_{g} is an important lever for increasing conductivity, but that there is still a spread of conductivity performance between systems that have essentially the same T_{g} but different chemistries [32], For energy storage applications, maximizing the Li⁺ contribution to the total conductivity is important, and is quantified by the transference number (t₊). Typically, a large Li+ t₊ reduces the concentration polarization during battery operation, yielding higher power densities [33], However, the determination of the transference number is challenging for polymer electrolytes systems [34], Several electrochemical techniques exist for extracting transference number values, although all come with drawbacks. Chronoamperometry, for instance, becomes inaccurate in systems with high interfacial impedance or ion pairing, and for polymeric systems which require large cell polarizations [35-37], More rigorous methods for the determination of transference numbers stem from thermodynamic considerations, but are limited by experimental complexity and propensity for propagation error, and are influenced by the solid electrolyte interphase that typically forms between the polymer and Li metal foil [11,38]. Here, we use ⁷Li and ¹⁹F pulsed-field gradient nuclear magnetic resonance (PFG-NMR) to determine the diffusion coefficients of the ions of interest, Li⁺ and TFSI⁻ [39], PFG-NMR typically measures the diffusion coefficient over a length-scale of a few micrometers, which means that the diffusion coefficient is therefore an average diffusion coefficient weighted by the time spent in the various mobile and immobile environments in the polymer.

In this example, the role of ligand density on T_{g}, total ionic conductivity and Li⁺ t₊ is explored for a series of sidechain grafted polymer electrolytes. A library of polymers was synthesized from a poly(vinyl methyl siloxane) backbone functionalized with varying ratios of imidazole ligands and ‘spacer’ side chains, chosen to remove residual vinyl reactive groups and to test for the role of spacer steric bulk on the electrolyte properties. It is shown that replacing the imidazole ligands with small ethane spacers enables a reduction in the polymer T_{g} of over 80° C., and a concomitant 10-fold conductivity increase. Interestingly, the use of phenyl spacers likewise results in dramatic decreases in T_{g} of about 60° C., yet leads to a decrease in the conductivity performance of the polymer electrolyte. After normalization of the conductivity data by the corresponding values of T_{g}, both polymers show a decrease in conductivity at low grafting density, though the conductivity of the ethane-imidazole series is insensitive to imidazole grafting density at grafting percentages above 30% imidazole. These results are examined based on approximations of molar volume of imidazole and salt concentration, which suggests that reducing the imidazole molar concentration below a certain threshold leads to reduced conductivity performance. Importantly, there is not a strict threshold of imidazole concentration which results in zero ionic conductivity, suggesting that static percolation theories indeed do not hold, and solvation site re-arrangement recovers some performance for even extremely low imidazole contents.

The Li⁺ transference behavior of the ethane-imidazole series was also studied using PFG-NMR and relaxometry. The Li⁺ t₊ decreases from 0.27 to 0.17 as the imidazole content is reduced to 30% of side chains. Thus, a maximum in cation conductivity exists, emphasizing the need to consider t₊ for ligand density optimization.

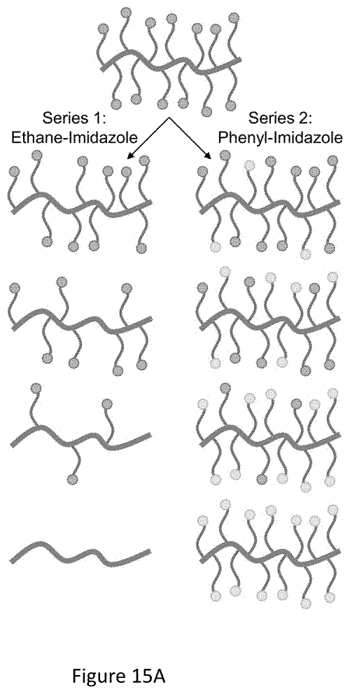

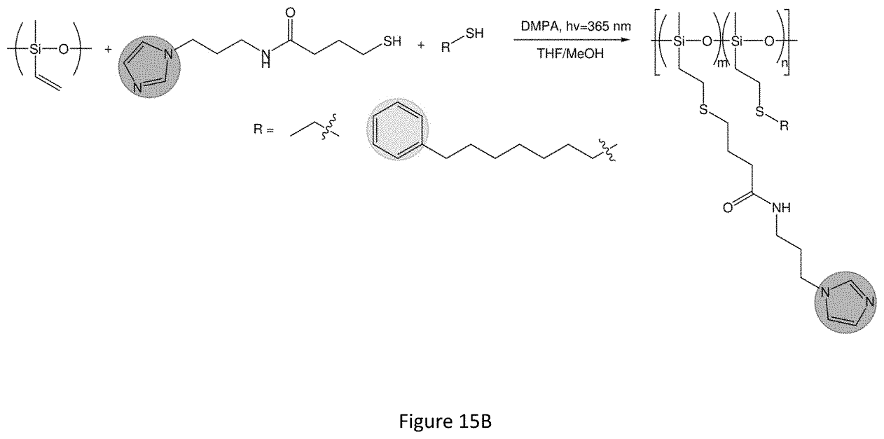

The two polymer series were designed to identify the role of the concentration of solvation sites (imidazole ligands) on both segmental dynamics and ion conduction (FIG. 15A). Imidazole ligands are attached to a poly(vinyl methyl siloxane) backbone using thiol-ene click chemistry (FIG. 15B). The remaining active vinyl functional groups are reacted with either ethane-thiol or phenyl-thiol. Ethane thiol was chosen as a small spacer unit to remove the residual vinyl functional groups and eliminate the possibility of unwanted reactions or cross-linking occurring in these polymers during processing or characterization. The phenyl-thiol spacers were chosen to maintain similar steric bulk to the imidazole ligand, while still removing the active coordination sites from the polymer. LiTFSI salt was then added to the polymer series at a few concentrations. The first concentration kept the molar ratio of Li⁺ to monomer repeat unit constant at 0.1. For the phenyl-imidazole system, this roughly also keeps the weight percent of salt constant (Table 4), while for the ethane-imidazole series, the weight percent changes due to the significant difference in molar mass between ethane-thiol and imidazole-thiol. The second salt concentration, explored only for the ethane-imidazole series, kept the molar ratio of Li⁺ to imidazole constant. This series tests the hypothesis that the salt dissociation is governed by the imidazole content. The total salt concentration added to the polymer varied more dramatically throughout the grafting density series for constant Li:imidazole (Table 4).

TABLE 4
Polymer characteristics. Polymer name corresponds to PVMS backbone, with phenyl-
carbon (‘Phc’) or ethane (‘Et’) inert side chains used to tune the
grafting density of imidazole (‘Im’) ligands. The percentage of imidazole
grafting density as determined by NMR is given as a number following the name.

| | | Polymer | mmol | | | | |
|---|---|---|---|---|---|---|---|
| | % | Molar | Imidazole | | | Salt | |
| | Imidazole | Mass | per Gram | | | Concentration | Salt |
| Name | (NMR) | (g/mol) | Polymer | Li:Monomer | Li:Imidazole | (mmol/cm³) | wt % |
| PVMS-Phc | 0% | 294 | 0 | 0.1 | N/A | 0.340 | 8.9 |
| PVMS-Phc-Im 14 | 14% | 296.72 | 0.472 | 0.1 | 0.714 | 0.337 | 8.82 |
| PVMS-Phc-Im 40 | 40% | 301.76 | 1.326 | 0.1 | 0.25 | 0.331 | 8.69 |
| PVMS-Phc-Im 72 | 72% | 307.97 | 2.338 | 0.1 | 0.139 | 0.325 | 8.53 |
| PVMS-Et | 0% | 148 | 0 | 0.1 | N/A | 0.676 | 16.25 |
| PVMS-Et-Im 7 | 7% | 159.58 | 0.439 | 0.1 | 1.429 | 0.627 | 15.25 |
| | 7% | 159.58 | 0.439 | 0.05 | 0.714 | 0.313 | 8.25 |
| | 7% | 159.58 | 0.439 | 0.007 | 0.1 | 0.044 | 1.24 |
| PVMS-Et-Im 20 | 20% | 181.08 | 1.104 | 0.1 | 0.5 | 0.552 | 13.68 |
| PVMS-Et-Im 29 | 29% | 195.97 | 1.48 | 0.1 | 0.345 | 0.510 | 12.78 |
| PVMS-Et-Im 33 | 33% | 202.58 | 1.629 | 0.1 | 0.303 | 0.494 | 12.41 |
| | 33% | 202.58 | 1.629 | 0.033 | 0.1 | 0.163 | 4.47 |
| PVMS-Et-Im 49 | 49% | 229.05 | 2.139 | 0.1 | 0.204 | 0.437 | 11.14 |
| | 49% | 229.05 | 2.139 | 0.049 | 0.1 | 0.214 | 5.79 |
| PVMS-Et-Im 71 | 71% | 265.43 | 2.675 | 0.1 | 0.141 | 0.377 | 9.76 |
| | 71% | 265.43 | 2.675 | 0.071 | 0.1 | 0.267 | 7.13 |
| PVMS-Im | 100% | 313.4 | 3.191 | 0.1 | 0.1 | 0.319 | 8.39 |

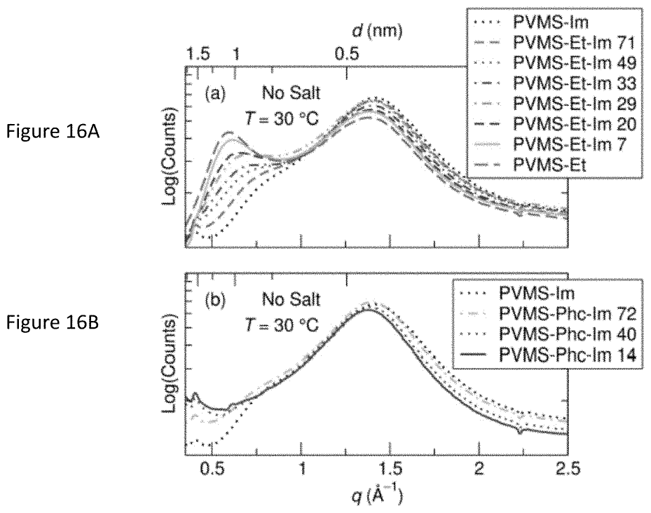

Wide-angle X-ray scattering (WAXS) shows changes in polymer structure with lower grafting density for the ethane-imidazole polymer series but no change for the phenyl-imidazole series (FIG. 16). In addition to a broad amorphous halo peak around 0.4 nm, a shoulder peak emerges at about 1 nm as imidazole content within the ethane-imidazole polymers is reduced. This peak is the most intense when no imidazole is present in the polymer, signifying the ethane spacer is responsible for this added structure. The ion conduction properties are measured at temperatures above the glass transition temperature, these polymers are highly mobile locally, and any aggregation or phase segregation undergoes significant fluctuations with time. These fluctuations likely reduce the importance of this polymer structure on the ion conduction results.

Salt addition to the polymers often results in the emergence of an ‘ion aggregation’ peak at length scales between 3 nm and 6 nm, as probed via small-angle X-ray scattering (SAXS). The interpretation of this aggregate peak is challenging, but is generally believed to arise from scattering between discrete aggregates, or, for stringy or percolated aggregates, both inter- and intra-aggregate scattering [25], Thus, for discrete aggregates it measures the spacing between aggregates, while for stringy or percolated aggregates it can also measure the distance between various segments of a single aggregate.

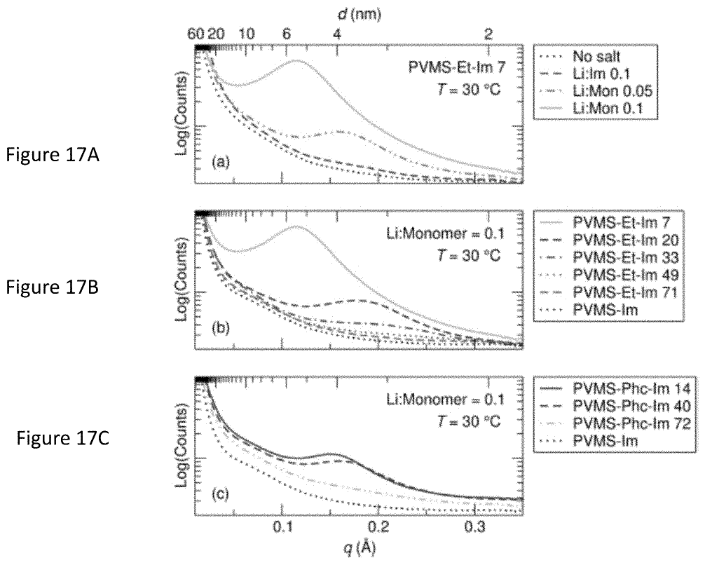

As salt concentration is increased in the PVMS-Et-Im 7 polymer, the aggregate peak grows in intensity and shifts to larger length scales, suggesting increased spacing between aggregated domains (FIG. 17A). A very low salt concentration does not result in ion aggregation in this polymer. The increase in peak intensity follows from the increase in ion concentration, and indicates that a larger number of ions aggregate as the concentration is increased. The increase in spacing between aggregates is less intuitive, as one might expect the aggregates to become larger and more numerous, which would lead to smaller inter-aggregate spacings. However, it is likely that the aggregates formed in these side-chain grafted imidazole systems are stringy or even percolated [13], In that case, higher salt concentrations may be elongating aggregate domains in such a way to increase the spacing between the closest distance between neighboring aggregates, or between parts of an individual aggregate. Interestingly, salt addition does not change the intermediate structure probed in the WAXS regime.

Increasing imidazole content for the ethane-imidazole polymer series at a constant Li⁺ to monomer ratio of 0.1 results in a smaller aggregation peak intensity and a shift in the correlation distance to smaller length scales (FIG. 17B). The reduction in peak intensity is likely a result of two factors. First, the higher imidazole grafting percentages result in a lower overall salt concentration, due to the increase in polymer volume from the imidazole spacer compared to the ethane spacer (see Table 4). Second, as the imidazole content increases the dielectric constant of the polymer matrix is expected to increase, which results in larger debye screening lengths and therefore less ion aggregation. The shift in peak position to smaller length scales with increasing imidazole content might result from the decreased spacing between imidazoles. Since the salt interacts most strongly with the imidazole ligands in the polymer, it likely segregates to regions of higher imidazole density, resulting in ion aggregate clusters that are spaced closer together as imidazole content increases.

A similar trend of decreasing aggregate correlation distance with increasing imidazole content at a constant Li⁺ to monomer ratio of 0.1 exists for the imidazole-phenyl series (FIG. 17C). Compared to the ethane-imidazole polymer series, the aggregation scattering peak for the phenyl-imidazole is less intense, and is shifted to smaller length scales for a similar imidazole grafting percentage. The additional steric bulk of the phenyl group results in a lower density of imidazole functional groups for the phenyl-imidazole series at the same grafting percentage relative to the ethane-imidazole series (Table 4), which could be a contributing factor to the intensity of the peaks. The smaller aggregate peak distance in the phenyl system might be a result of the extra bulk of the phenyl spacers which more effectively prevents ion-imidazole clusters from forming and results in aggregate clusters spaced farther apart instead.

In addition to affecting polymer structure and propensity for ion aggregation, a lower grafting density of imidazole ligands results in significant decrease of the polymer T_{g}, as seen in FIG. 18. Before the addition of LiTFSI salt, the ethane-imidazole polymer series T_{g} ranges from −8° C. for fully imidazole-functionalized to −90° C. for fully ethane-functionalized (FIG. 18A). The T_{g} decrease for the phenyl-imidazole series is slightly smaller, with a drop to −68° C. for a fully phenyl-functionalized polymer (FIG. 18B). Expected T_{g} values for copolymers can be estimated using the Fox equation [41] but consistently underestimate the measured T_{g} for both series. The changing concentration of hydrogen-bonding amide functionality is likely playing a large role. It is also possible that microphase separation or clustering of the polar imidazole side-chains away from the non-polar spacer units (as suggested by the X-ray scattering profiles for the ethane-imidazole polymer series) could be driving additional T_{g} increases for the copolymer series.

The significant decrease in T_{g} with lower imidazole content for both the ethane- and phenyl-imidazole series suggests that two effects contribute to the polymer T_{g}. First, the removal of the imidazole side chain eliminates both the polar imidazole group and the amide functional group, which is expected to participate in hydrogen bonding and dynamic cross-linking of the polymer. Elimination of hydrogen bonding and polar groups results in a −60° C. drop in T_{g} as measured for the phenyl-imidazole series. The ethane-imidazole series further eliminates the steric bulk of the phenyl unit, replacing it with a small ethane cap instead. The smaller side chain reduces steric crowding of the polymer backbone, and results in a further −20° C. drop of the polymer T_{g}.

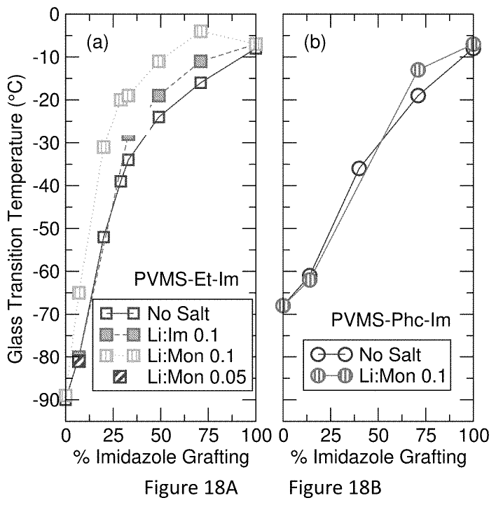

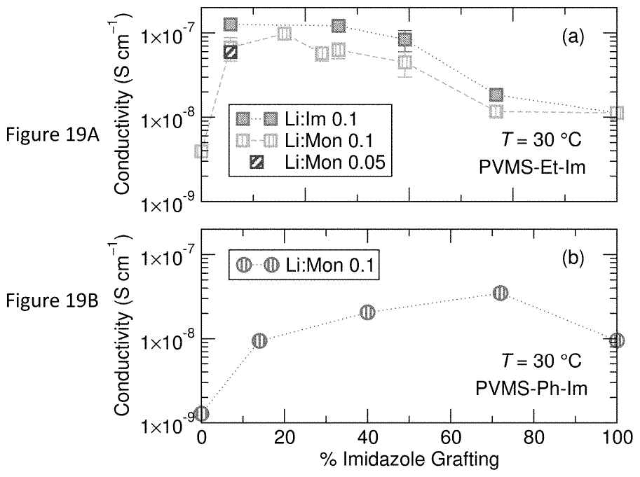

While the ethane- and phenyl-imidazole series show similar T_{g} behavior, they differ remarkedly in their conductivity trend with changing grafting density at a constant temperature of 30° C., likely due to the difference in steric bulk of the phenyl versus ethane spacer. The ethane-imidazole polymer series undergoes a steady increase of about an order of magnitude in ionic conductivity as the imidazole grafting density is reduced from 100% to around 30% (FIG. 19a). This conductivity increase reaches a plateau at imidazole contents less than 30%, until all the imidazole is removed from the polymer, which results in a significant drop in conductivity due to the poor solvation and conduction properties of the siloxane backbone and thioether functional group. Interestingly, for the phenyl-imidazole series, the conductivity peaks at a relatively high grafting density of 72%, and subsequently decreases with lower imidazole content (FIG. 19b). The maximum conductivity increase is also only approximately a factor of 2. The non-monotonic evolution of the conductivity with grafting density differs from the continually decreasing T_{g} trend. This result highlights that T_{g} is not the only important factor in controlling ionic conductivity. Instead, the difference in steric bulk of the phenyl group in comparison to the ethane spacer might be playing a role in determining the conductivity performance.

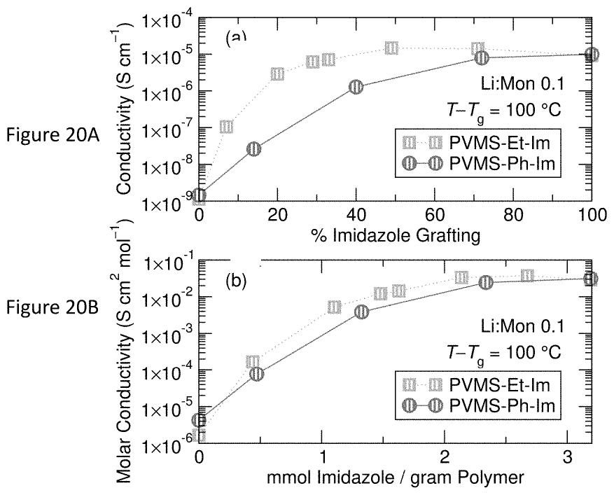

Analyzing conductivity at a constant temperature relative to T_{g} reveals a threshold grafting density above which extra imidazole is unimportant for the conductivity mechanism. FIG. 20a shows conductivity as a function of imidazole grafting percentage for both series at T−T_{g}=100, which was chosen because this temperature was accessible for conductivity measurements for all the samples within both series (Table 5).

TABLE 5
Measured Temperature and conductivity values for samples at T −
T_{g} = 100 at a salt concentration of Li:Monomer = 0.1

| | T = 100 + T_{g} | Conductivity | Standard |
|---|---|---|---|
| Sample | (° C.) | (S/cm) | deviation |
| PVMS-Et Li:Mon 0.1 | 11 | 1.1310⁻⁹ | N/A |
| PVMS-Et-Im 7 Li:Mon 0.1 | 35 | 1.0510⁻⁷ | 3.0410⁻⁸ |
| PVMS-Et-Im 20 Li:Mon 0.1 | 69 | 2.8810⁻⁶ | 7.510⁻⁸ |
| PVMS-Et-Im 29 Li:Mon 0.1 | 80 | 6.1610⁻⁶ | 4.0810⁻⁷ |
| PVMS-Et-Im 33 Li:Mon 0.1 | 81 | 7.1110⁻⁶ | 5.1310⁻⁷ |
| PVMS-Et-Im 49 Li:Mon 0.1 | 89 | 1.4710⁻⁵ | 2.2110⁻⁶ |
| PVMS-Et-Im 71 Li:Mon 0.1 | 96 | 1.4110⁻⁵ | 2.4910⁻⁶ |
| PVMS-Im Li:Mon 0.1 | 93 | 9.2110⁻⁶ | 1.0910⁻⁶ |
| PVMS-Phc Li:Mon 0.1 | 32 | 1.4510⁻⁹ | N/A |
| PVMS-Phc-Im 14 Li:Mon 0.1 | 38 | 2.6010⁻⁸ | N/A |
| PVMS-Phc-Im 40 Li:Mon 0.1 | 64 | 1.2810⁻⁶ | N/A |
| PVMS-Phc-Im 72 Li:Mon 0.1 | 87 | 7.9310⁻⁶ | 8.8410⁻⁷ |

Eliminating the contribution due to changing T_{g} within each series isolates the role of spacer concentration and identity on conductivity performance. This representation shows a significantly different picture to the un-normalized conductivity data shown in FIG. 19.

The ethane-imidazole exhibits a plateau in ionic conductivity at imidazole grafting densities above ˜30%, suggesting that at these imidazole concentrations the conductivity is unaffected by a change in the imidazole content. This is an important design rule, as it indicates that increasing the concentration of solvating groups does not always result in improved ion transport. The phenyl-imidazole series, on the other hand, shows a continuous decline in conductivity with lower imidazole content, though the initial decrease in imidazole content to 72% only has minimal effect.

Below a grafting density threshold, which differs between the two series, the conductivity begins to decline more steeply, but also does not immediately reduce to zero. While it is tempting to discuss this decline in terms of a percolation threshold, static percolation theory does not hold in polymer electrolytes significantly above their T_{g} [28,42] In these polymers, significant segmental motion occurs, and solvation site rearrangement likely plays an important role in determining conductivity performance at lower grafting densities.

Instead, these results can be understood in terms of dynamic percolation theory, which suggests ion conductivity depends on both the rate of solvation site re-arrangement and the rate of ion hopping. The T_{g}-normalized conductivity representation eliminates differences in solvation site re-arrangement between the polymer electrolytes, enabling understanding of the impact of imidazole content on ion hopping rates. FIG. 20A shows that ion hopping rates are invariant at high imidazole contents, especially for the ethane-imidazole series, but drop steadily below a threshold imidazole density. High imidazole contents likely form a percolated network of solvation sites, resulting constant solvation site connectivity and thus invariant ion hopping rates. When the ligand concentration drops below a threshold, the distribution and connectivity of solvation sites changes with imidazole content, resulting in decreasing ion hopping rates and thus lower/g-normalized conductivity. The role of solvation site distribution on ion hopping rates was discussed in Webb et al. [23], Note, this/g-normalized conductivity representation eliminates differences in solvation site re-arrangement, but does not eliminate the importance of such re-arrangement, as the conductivities here are 100 degrees above T %. This is why the conductivity declines but does not reduce to zero after the threshold imidazole content.

The difference in grafting percentage below which a conductivity drop is seen in the two series likely results from the significantly different steric bulk, or volume, of the ethane versus the phenyl spacer units used in this study. It is possible to convert the imidazole grafting percentage into a mass-normalized imidazole concentration by calculating the mmol of imidazole per gram of each polymer. If the densities of the polymers within the series does not appreciably change, then this mmol imidazole per gram polymer should translate directly into a volumetric concentration (mmol cm⁻³) of imidazole. To better compare the two series, the conductivity is also normalized into an approximate molar conductivity. This requires assuming full salt dissociation and a constant polymer density (here taken as 1 g cm⁻³) for all polymers. This form of normalization is commonly applied to both liquid and polymer electrolytes to aid in comparability between studies [43-46], FIG. 20b shows the scaled conductivity behavior for the ethane- and phenyl-imidazole series with a Li:monomer ratio of 0.1. This approximate normalization scheme provides much stronger agreement between the two series in terms of the threshold imidazole content that results in a drop in conductivity performance.

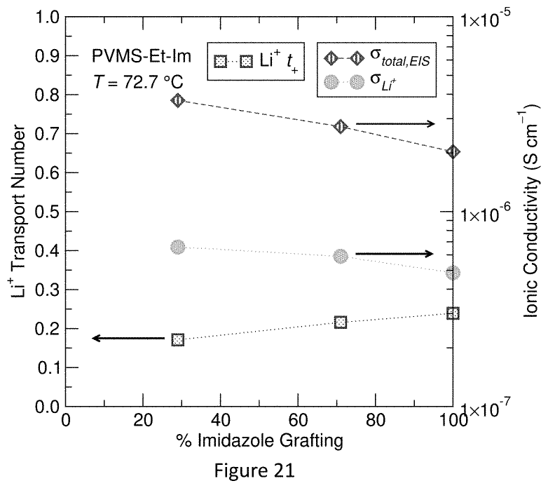

Unlike the total (cation+anion) conductivity, which decreases with increasing imidazole content at a fixed temperature, the Li⁺ transport number increases with increasing grafting density when measured at 72.7° C., suggesting lithium mobility is preferentially enhanced over the TFSI⁻ at higher imidazole densities. This could be due to shorter distances between imidazole sites, potentially reducing the energy barrier for lithium hopping. For the 29% and 71% imidazole grafted samples the transport number was observed to increase with temperature. It is likely that at higher temperature the energy required for Li⁺ binding/unbinding to the imidazole (and amide) is more easily overcome, and therefore speeds up the Li⁺ conduction process, leading to faster Li⁺ conduction while TFSI⁻ conduction is relatively unchanged. Conversely, the 100% grafted sample is constant over the limited temperature range accessible for these systems. The diffusion and transport number values for all samples measured are displayed in Table 6. FIG. 21 plots the Li⁺ the transport number as a function of Imidazole grafting percentage.

TABLE 6
Li+ (D_{Li+}) and TFSI⁻ (D_{TFSI}⁻) self-diffusion constants, transport
numbers (t+), calculated conductivity arising from the Li⁺ (σ+) and
TFSI⁻ (σ−), and total calculated conductivity (σₜₒₜₐₗ) for three PVMS-Et-Im
polymers with varying imidazole grafting density. All polymers were characterized
with a 0.1 Li:monomer LiTFSI and measured at 72.7° C and 81.4° C.

| | | Diffusion | | | | | | |
|---|---|---|---|---|---|---|---|---|
| | Grafting | (×10⁻¹³ m²s⁻¹) | | t₊ | Ionic Conductivity (×10⁻⁶ Scm⁻¹) | | | |
| | Density (%) | D [symbol] | D [symbol] | (%) | σ₊ | σ₋ | σₜₒₜₐₗ | σ_{measured} |
| 72.7° C. | 29 | 0.62 | 2.87 | 17.7 | 1.02 | 4.74 | 5.76 | 3.72 |
| | 71 | 0.53 | 1.91 | 21.6 | 0.64 | 2.33 | 2.97 | 2.73 |
| | 100 | 1.03 | 3.29 | 23.9 | 1.06 | 3.04 | 4.46 | 2.03 |
| 81.4° C. | 29 | 1.11 | 4.88 | 18.6 | 1.79 | 7.86 | 9.65 | 6.63 |
| | 71 | 1.14 | 3.59 | 24.1 | 1.36 | 4.27 | 5.63 | 5.24 |
| | 100 | 1.92 | 6.19 | 23.7 | 1.93 | 6.24 | 8.17 | 5.38 |

[symbol]

indicates data missing or illegible when filed

The magnitude of the activation energies for the diffusion and conductivity are similar, which is expected in the absence of correlated diffusion. Interestingly, the 100% grafted sample exhibits the fastest diffusion for both the Li⁺ and TFSI⁻ ions, followed by the 29% grafted sample, with the slowest diffusing sample being the 71% grafted polymer electrolyte. Activation energies for ionic diffusion can be estimated by fitting an Arrhenius equation to PFG-NMR data. These activation energies are determined to be 68.4 kJ mol⁻¹, 90.1 kJ mol⁻¹ and 72.54 kJ mol⁻¹ for Li⁺ ions in the 29%, 71% and 100% grafted samples, respectively. For TFSI⁻ ions, activation energies of 61.8 kJ mol⁻¹, 73.5 kJ mol⁻¹ and 73.6 kJ mol⁻¹ are obtained for the 29%, 71% and 100% grafted samples, respectively. The limited temperature range probed may result in inaccurate diffusion barriers; however, these activation energies are still used as a rough estimate to compare these diffusion measurements to alternate NMR techniques. It should be noted that the conductivity and diffusion measurements are expected to follow Vogel-Fulcher-Tamman (VFT) theory rather than Arrhenius behavior, however, over the limited temperature range measured the latter theory provides good estimates. For comparison, the activation energies determined from the total ionic conductivity measurements are 69.2 kJ mol⁻¹, 77.8 kJ mol⁻¹ and 98.3 kJ mol⁻¹ for the 29%, 71% and 100% grafted samples respectively.

Calculating an ideal expected ionic conductivity from PFG diffusion measurements consistently overestimates the conductivity compared to the total ionic conductivity measured by impedance spectroscopy (EIS), suggesting that not all ions in the system contribute to the conductivity.

### Fifth Example: Polymer Plasticization Using Additives to Further Lower T_{g} and Improved Conductivity

Plasticizers (additives) are low molecular weight substances added to a polymer to promote its plasticity and flexibility. Addition of plasticizers to polymer electrolytes can lower the glass transition temperature of the polymers, so as to further increase the polymer ion conductivity. Ion-solvating plasticizer will also change ion conductivity by modifying ion concentration and mobility.

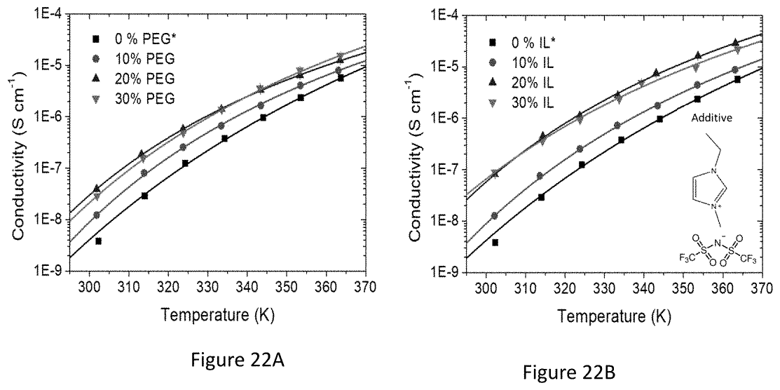

One non-volatile molecular plasticizer (poly(ethylene glycol), molecular weight of 400 Dalton) and one ionic liquid plasticizer (l-ethyl-3-methylimidazolium TFSI, mp˜−15° C.) of 10, 20 and 30% wt. were blended with the amide containing PMS-6-Amide-3-Im polymer and the resulting ion conductivity (1.5 Li:Im ratio) is shown in FIG. 22. The 20% wt. 1-ethyl-3-methylimidazolium TFSI sample showed a 30-fold increase over the un-plasticized sample which has conductivity on the order of 10⁻⁹ Scm⁻¹ at room temperature. The blend conductivity has little change when 1-ethyl-3-methylimidazolium loading was further increased to 30% wt. PEG additive has a similar but smaller effect on blend conductivity. This demonstrated that adding a plasticizer can further increase the polyelectrolyte ionic conductivity in our systems.

### Example Polymer Structures

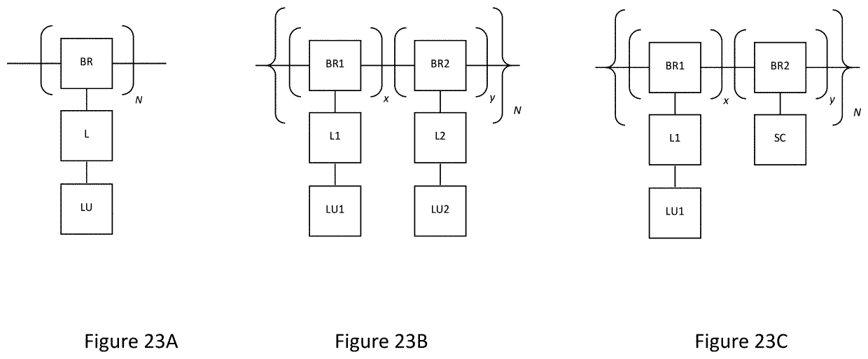

FIG. 23A illustrates a polymer structure according to one examples, wherein BR is a backbone repeating unit each independently comprising, but not limited to, a monomer of a siloxane, an ether, a butadiene, an ethylene, a phosphazene, an acrylate, an carbonate, an lactide or derivatives thereof, or combination thereof. The polymer backbone can be selected from any low T_{g} polymers. LU is an ion-binding ligand group covalently bonded to the backbone through a linker L. L is a spacer or linker unit which covalently bond each ligand group to the backbone. The linker (spacer) can be, but is not limited to, an alkylene chain, an ethylene chain, an ether chain, a thioether chain, a siloxane chain or the combination thereof. In one or more examples, the linker is —(CH₂)ₚS—(CH₂)_{q}—, where p and q are integers between 0 to 20. In one or more examples, the linker is —(CH₂)ₚSi—(CH₂)_{q}—, where p and q are integers between 0 to 20. In one or more examples, p is 2. In one or more examples, the linker is —(OSi(CH₂)₂)ₚ—, where p is an integer between 0 to 20. Nis the backbone degree of polymerization. N can be any integer from 5 to 5000. In one or more examples, n is from 30 to 500. In one or more examples, BR is a siloxane repeating unit. LU is an imidazole or nitrile ligand.

FIG. 23B illustrates a polymer structure according to another example, wherein BR1 and BR2 are backbone repeating units that each can independently comprise, but are not limited to, a monomer of a siloxane, an ether, a butadiene, an ethylene, a phosphazene, an acrylate, an carbonate, an lactide or derivatives thereof, or combination thereof. The polymer backbone can be selected from any low T_{g} polymers. LU1 and LU2 are ion-binding ligand units covalently bonded to the backbone through linkers L1 and L2. L1 and L2 are spacer or linker units which covalently bond each ligand group to the backbone. The linker (spacer) can be, but is not limited to, an alkylene chain, an ethylene chain, an ether chain, a thioether chain, a siloxane chain or the combination thereof. In one or more examples, the linkers are —(CH₂)ₚS—(CH₂)_{q}—, where p and q are integers between 0 to 20. In one or more examples, the linkers are —(CH₂)ₚSi—(CH₂)_{q}—, where p and q are integers between 0 to 20. In one or more examples, p is 2. In one or more examples, the linkers are —(OSi(CH₂)₂)ₚ—, where p is an integer between 0 to 20. N is the backbone degree of polymerization. N can be any integer from 5 to 5000. In one or more examples, n is from 30 to 500. x and y are the number of BR1 and BR2 repeating units in each block, statistical or random sequence of the copolymer.

FIG. 23C illustrates a polymer structure according to yet another example, wherein BR1 and BR2 are backbone repeating units each independently comprising, but not limited to, a monomer of a siloxane, an ether, a butadiene, an ethylene, a phosphazene, an acrylate, an carbonate, an lactide or derivatives thereof, or combination thereof. The polymer backbone can be selected from any low T_{g} polymers. LU1 is an ion-binding ligand unit covalently bonded to the backbone through linker L1. L1 is a spacer or linker unit which covalently bond each ligand group to the backbone. The linker (spacer) can be, but is not limited to an alkylene chain, an ethylene chain, an ether chain, a thioether chain, a siloxane chain or the combination thereof. In one or more examples, the linker is —(CH₂)ₚS—(CH₂)_{q}—, where p and q are integers between 0 to 20. In one or more examples, the linker is —(CH₂)ₚSi—(CH₂)_{q}—, where p and q are integers between 0 to 20. In one or more examples, the linker is —(OSi(CH₂)₂)ₚ—, where p is an integer between 0 to 20. SC is a side chain which covalently bond to the polymer backbone but doesn't comprise any ligand group. In one or more examples, SC is —(CH₂)ₚS—(CH₂)_{q}CH₃, where p and q are integers between 0 to 20. In one or more examples, SC is —(CH₂)ₚSi—(CH₂)_{q}CH₃, where p and q are integers between 0 to 20. In one or more examples, p is 2. In one or more examples, the linker is —(OSi(CH₂)₂)ₚCH₃, where p is an integer between 0 to 20. N is the backbone degree of polymerization. N can be any integer from 5 to 5000. In one or more examples, n is from 30 to 500. x and y are the number of BR1 and BR2 repeating units in each block, statistical or random sequence of the copolymer. In one or more examples, BR1 and BR2 are siloxane repeating units. LU1 is an imidazole or nitrile ligand.

Experimental Methods for the Examples

Synthetic Procedure:

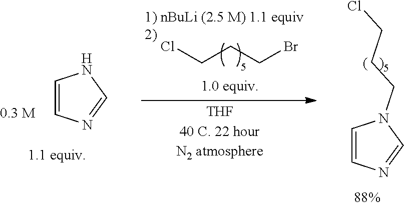

To an oven dried round bottom flask equipped with a magnetic stir bar, imidazole and half the volume of the total THF was added 1.1 equiv. of 2.5 M nBuLi in hexanes at ambient temperature. This solution was stirred for 30 minutes. To this flask was added a solution of 1-bromo-7-chloroheptane (CAS number: 68105-93-1) in THF to a total concentration of 0.3 M in imidazole. This reaction mixture was placed in an oil bath preheated to 40° C. and stirred under dinitrogen atmosphere for 22 hours. WORKUP: filter the crude mixture through a pad of silica and concentrate.

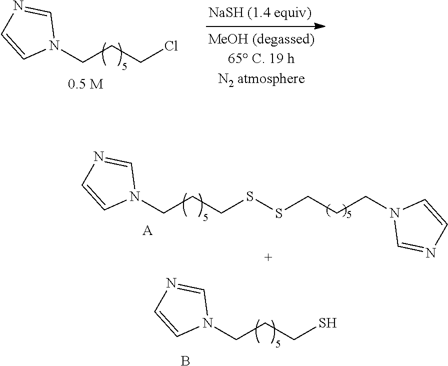

To an oven dried round bottom flask equipped with a magnetic stir bar was added NaSH (1.4 equiv.) followed by a solution of 1-(7-chloroheptyl)-1H-imidazole in degassed absolute MeOH and refluxed overnight under dinitrogen atmosphere. WORKUP: filter the crude mixture through a pad of silica and concentrate. If product is a disulfide (diagnostic ¹H triplet signal at 2.63 ppm in CDCl₃) refer to procedure shown below. If product is thiol (diagnostic ¹H quartet signal at 2.50 ppm in CDCl₃), use directly for the thiol-ene “click” reaction.

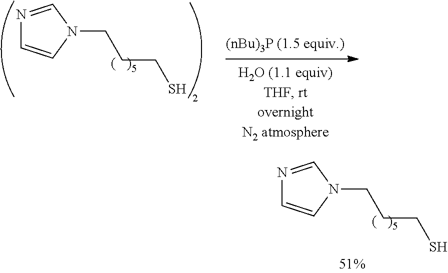

To an oven dried round bottom flask equipped with a magnetic stir bar were added disulfide, (1 equiv.), tributylphosphine (1.5 equiv.), deionized water (1.1 equiv.) followed by THF to a concentration of 0.4 M in disulfide. This reaction mixture was allowed to stir at ambient temperature overnight under inert atmosphere. WORKUP: concentrate and use for the thiol-ene “click” reaction.

### b. Example Thiol-Ene “Click” Reaction (Amide-free PMS-10-Im)

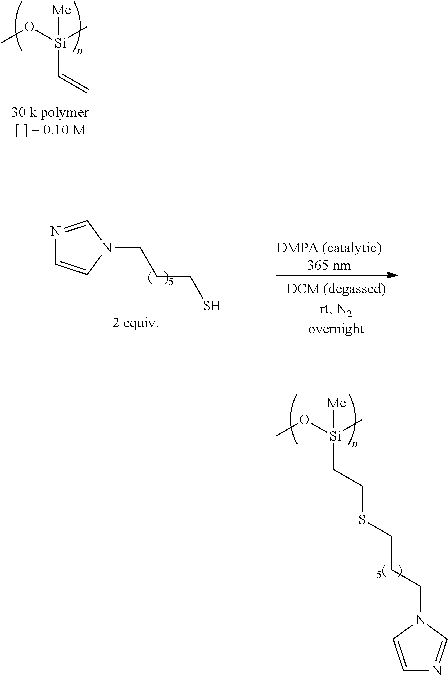

To an oven dried round bottom flask equipped with a magnetic stir bar was added poly(vinylmethyl siloxane) PVMS (1.0 equiv.) followed by the addition of a 7-(1H-imidazol-1-yl)heptane-1-thiol (2.0 equiv.), 2,2-dimethoxy-2-phenylacetophenone (DMPA) (10 mol %) and degassed dry DCM. This reaction mixture was irradiated with 365 nm light overnight under dinitrogen atmosphere. Upon the completion of the “click” reaction the resulting polymer was purified through dialysis in absolute methanol or by precipitation in THF, then dried under high vacuum.

FIG. 7 illustrates the synthesis of amide-free aliphatic thiol containing heterocycle series (heterocycles D through K). Different bases including n-BuLi, NaH, KI/K₂CO₃ can be used for the alkylation step depending on the acidity of the N—H proton.

Example Polymer synthesis with PVMS: Two batches of poly(vinyl methyl siloxane) (PVMS) were synthesized by anionic polymerization using standard Schlenk line techniques. For the first, 200 mL of uninhibited and dry THF was further purified by distillation over n-butyl lithium and dried by the addition of 260 μL of sec-butyl lithium at 0° C., after which the solution was allowed to warm to room temperature. The monomer, 1,3,5-trivinyl-1,3,5-trimethyl-cyclotrisiloxane (Gelest), was degassed by four freeze-pump-thaw cycles and used without additional purification. 260 μL of sec-butyl lithium was added to THF at 0° C. as initiator, followed by the addition of 15.5 mL of degassed monomer. The reaction was allowed to proceed for 10 min at 0° C. before termination with degassed methanol. The solution was concentrated and precipitated in methanol three times. The second batch followed a similar synthesis procedure, but with 50 mL of THF dried with the addition of 400 μL sec-butyl lithium. 8.5 mL degassed monomer was initiated with 75 μL n-butyl lithium. The reaction was allowed to proceed for 3 h at 0° C. before termination with degassed methanol. The polymer was purified through three precipitations in water, a 2-day dialysis in THF, and filtering through a PTFE plug. Size exclusion chromatography (SEC) was performed on a Waters Alliance HPLC instrument using a refractive index detector and Agilent PLgel 5 μm MiniMIX-D column at 35° C. with THF as the eluent. Dispersity index (Ð) was determined against polystyrene calibration standards (Agilent Technologies). The PVMS molecular weight was estimated from SEC using Polystyrene standards.

Amide-containing PMS-6-Amide-3-Im. N-(2-(1H-Imidazol-1-yl)propyl)-4-mercaptobutanamide (Im-SH) was synthesized as previously reported by Sanoja et al.[8] Dried PVMS was weighed out and dissolved in THF. An appropriate mass of Im-SH was dissolved in methanol and added to the flask to achieve a thiol to vinyl ratio of 1.75:1. DMPA (2,2-Dimethoxy-2-phenylacetophenone) was added as an initiator to vinyl ratio of 0.2:1. The final methanol/THF solvent ratio was adjusted to be 20/80 to maintain solubility during reaction, with a 0.1 M PVMS concentration. The reaction was degassed with nitrogen for 30 min, after which the reaction was allowed to proceed under UV (365 nm) light for 2 h with continuous stirring. The polymer was purified by precipitation in acetonitrile, then dried in vacuo at 55° C. in the presence of phosphorous pentoxide and immediately transferred to a nitrogen glove box. Polymer purification: the final polymer product can be purified by the following options depending on their solubility: 1. Dissolve in small amount of MeOH the precipitate from THF; 2. Dissolve in dichloromethane and precipitate from MeOH; 3. Dissolve in dichloromethane and precipitate from ether; 4. Dissolve in dichloromethane and precipitate from MeOH; 5. Dissolve in THF and precipitate from MeOH; These steps can be repeated multiple times for better product purity.

Salt Addition

Polymers were weighed into 7 mL vials and dissolved in anhydrous methanol or anhydrous THF (for low imidazole content polymers) inside a nitrogen glove box. Stock solutions of lithium bis(trifluoromethylsulfonyl)imide (LiTFSI, Alfa Aesar) ranging from 0.1 M to 1 M were prepared using anhydrous methanol. Appropriate volumes of LiTFSI stock solution were added to each polymer vial to achieve nominal molar ratios of Li⁺ to imidazole of 0.1, or Li⁺ to monomer of 0.6, 0.4, 0.3, 0.1, 0.05, 0.03 or 0.01. The sample vials were sealed, removed from the glovebox and frozen in liquid nitrogen before being opened and quickly transferred to a vacuum oven and dried in vacuo (1×10⁻³ Torr) at room temperature overnight, and then at 60° C. for 24 h. The samples were then transferred to a high vacuum oven (3×10⁻⁸ Torr) at 60° C. for 24 h to ensure complete removal of solvent. Finally, the samples were transferred into a nitrogen glove box for storage and measurement.

Ionic Conductivity Measurement

Total ionic conductivity was measured as a function of temperature on samples sandwiched between parallel ITO blocking electrodes using electrochemical impedance spectroscopy (EIS). The ITO-coated glass electrodes (Thin Film Devices) were cleaned by sonication for 5 min each in detergent, DI water, acetone and isopropyl alcohol, followed by a 5 min UV/ozone treatment (Jelight Company Inc., Model 18). The electrode thicknesses were measured using a micrometer, after which a double-sided Kapton tape spacer with a ⅛″ hole was added to one electrode. Polymer samples were loaded into the hole in the Kapton spacer in a nitrogen filled glove box. Samples were heated to about 30° C. above their T_{g} before being sealed with a second ITO electrode. All samples were then heated to 110° C. and pressed in a hand press. The final stack thickness was measured using a micrometer, and the sample thickness was determined by subtracting the electrode thicknesses. EIS was measured with a Biologic SP-200 potentiostat using a sinusoidal 100 mV signal from 1 MHz to 1 Hz at temperatures ranging from 30° C. to 110° C. The data was converted into dielectric storage and loss, and the ionic conductivities determined from the real component of conductivity at the maximum in tan(δ).[40] Three samples were measured for most compositions, with errors reported as standard deviations from the mean.

Thermal Characterization

Aluminum DSC pans were loaded with polymer samples in a nitrogen filled glove box and briefly exposed to air during sealing of the pans. The glass transition temperature (T_{g}) of each sample was measured using a Perkin Elmer DSC 8000 or TA Instruments Q2000 DSC on second heating at 20° C. min⁻¹ at the midpoint of the step transition.

X-Ray Scattering

X-ray scattering was performed as a function of temperature at the National Synchrotron Light Source II (NSLS-II, beamline 11-BM, Brookhaven National Laboratory) with an X-ray energy of 13.5 keV. Samples were packed into metal washers in a nitrogen glove box and covered on both sides with Kapton tape to prevent moisture uptake during measurement. Samples were equilibrated for 15 min at each temperature before collecting exposures. Data processing, including detector distance calibration using a silver behenate standard, reduction of 2D raw SAXS images into 1D intensity versus q curves and corrections for empty cell scattering were performed using the SciAnalysis software.

NMR

All ⁷Li and ¹⁹F solid-state NMR experiments were performed on either a 4 mm double resonance (HX) magic angle spinning (MAS) probe or a Diff50 probe fitted with either a 10 mm ¹⁹F or ⁷Li coil. All measurements were done on a 300 MHz (7.05 T) SWB Bruker NMR spectrometer. The polymer samples were packed into 4 mm MAS rotors by adding small amounts of polymer and centrifuging the sample down at 10 kHz for around 2 min each time, until the rotor was full. The rotor was packed inside a nitrogen or argon filled glovebox. The packed NMR rotor was then either used directly inside the 4 mm MAS probe or placed inside a 5 mm NMR tube equipped with a valve which kept an inert atmosphere around the sample. In both instances the sample was then temperature controlled by a flow of N² gas at a rate of 800 L hr⁻¹ which ensured an inert atmosphere. The temperature for each probe was calibrated using dry methanol and dry ethylene glycol at sub-ambient and elevated temperatures, respectively.

The power level used for the ⁷Li on the Diff50 probe was either 100 W or 200 W with a 90° pulse duration of around 16 μs (15.6 kHz) or 11 μs (22.7 kHz) respectively. The power level used for the ⁷Li on the 4 mm MAS probe was 76 W with a 90° pulse duration of around 3.3 μs (75.8 kHz). The power level used for the ¹⁹F insert on the Diff50 probe was 50 W with a 90° pulse duration of around lips (22 kHz). For all measurements, a recycle delay of around 5T₁ was applied before each scan when signal averaging, to allow full relaxation. The ⁷Li chemical shift was calibrated using a 1 M LiCl aqueous solution (single peak at 0 ppm) while the ¹⁹F chemical shift was referenced against a neat PF₆ sample exhibiting a doublet centered around 71.7 ppm.

The T₁ relaxation times were measured using a saturation recovery or inversion recovery sequence. The T₁ₚ experiments were measured by applying a spin-locking pulse during evolution of the spins following an initial 90° excitation pulse. The spin-locking frequency chosen here was 10 kHz for all samples. The PFG-NMR experiments used a diffusion sequence which includes a stimulated echo to protect the signal from T₂ relaxation, which is typically very short in these polymer systems. The diffusion was measured using a variable magnetic field gradient strength sequence, where the maximum gradient available was 2800 G cm⁻¹. The selection of gradient strength, along with the gradient duration (8) and diffusion time (A) were chosen for each measurement to ensure an appropriate window on the decay curve was acquired. The value of 8 and diffusion time A never exceeded 10 ms and 100 ms respectively and were kept as low as possible while using the strongest gradient strength possible in order to achieve the greatest possible signal to noise.

To determine the Li⁺ t₊ for these polymer systems, diffusion constants can be measured for the Li⁺ (D_{Li+}) and TFSI⁻ (D_{TFSI-}) ions using ⁷Li and ¹⁹F NMR, respectively. The transport number is then defined as the proportion of the conductivity which arises from the Li⁺ ions only. If the relative concentration of anions and cations are equal, then the transference number can be determined as follows:

$${t}_{+} = \frac{{σ}_{+}}{{σ}_{+} + {σ}_{-}} = \frac{{D}_{Li +}}{{D}_{{Li}^{+}} + {D}_{{TFSI}^{-}}} \qquad ( 1 )$$

The transport numbers, along with the diffusion coefficients, for three different imidazole grafting density polymer samples ranging from 29% up to fully grafted (100%) with ethane spacer units have been measured. These data were collected at 72.7° C. and 81.4° C. only as the conductivity levels for these polymers are relatively low, resulting in NMR spin-spin (T₂) relaxation times prohibitively short for diffusion measurements at ambient temperatures.

Typically, neither T₁ nor diffusion measurements give insight into the number of environments present, and instead provide information that is averaged over all environments. Spin-spin relaxation time (T₂) measurements can distinguish between multiple environments by fitting multiple exponents to the data. However, for the solid polymer systems of interest to this study, the T₂ values are prohibitively short to be measured with accuracy. T₁ₚ measurements are analogous to T₂ measurements, in that they are sensitive to multiple environments, with the additional benefit that the timescales are controllable through the choice of spin-lock frequency. Specifically, the T₁ₚ experiment measures T₁ in the xy plane using a low power spin-lock pulse applied during the duration of the evolution period of the sequence. There are limitations to the spin-lock frequencies that can be used due to heating effects, as the pulse power and duration are limited to prevent damage of the NMR probe. Here, a spin-locking frequency of 10 kHz (0.1 ms) was used for all samples, to establish whether multiple environments are present.

Experimental Methods for Fourth Example

Phenyl Thiol (Ph-SH) Synthesis

To an oven dried round bottom flask equipped with a magnetic stir bar was added NaSH (1.1 equiv.) followed by a 0.35 M solution of (7-bromoheptyl)-benzene in degassed absolute DMF at 0° C. This solution was stirred for one hour at ambient temperature under dinitrogen atmosphere. Upon completion, the reaction was diluted with DCM and extracted with brine 4 times, dried with Na₂SO₄ and concentrated in vacuo. The 7-phenylheptane-1-thiol was isolated in 93% yield and used for the next step without further purification. The ¹H-NMR data matched that of previously reported structure.

Polymer Functionalization

N-(2-(1H-Imidazol-1-yl)propyl)-4-mercaptobutanamide (Im-SH) was synthesized as previously reported by Sanoja et al.[8] Ethane thiol was purchased from Sigma Aldrich and used as-received. The PVMS polymer was dissolved in THF and added to a round bottom flask containing 2,2-Dimethoxy-2-phenylacetophenone (0.2 mol % with respect to vinyl functional handle). An appropriate mass of Im-SH was dissolved in methanol and added to the flask to vary the imidazole grafting density. For the ethane-imidazole series, an appropriate amount of ethane thiol was added volumetrically using a syringe. For the phenyl-imidazole series, the Ph-SH was dissolved in THF and added into the flask. The total thiol to vinyl ratio was kept constant at 1.75:1. The final methanol/THF solvent ratio was adjusted to be 20/80 to maintain solubility during all reactions. The reaction was degassed with nitrogen for 30 min, after which the reaction was allowed to proceed under UV (365 nm) light for 2 h. The polymers were purified either by precipitation in acetonitrile, methanol or water, or through dialysis in methanol/THF (50/50) solutions (SnakeSkin dialysis tubing with a 3.5 kDa MW cutoff, and solvent exchange every 12 h for a total of 5 to 7 times). The polymers were then dried in vacuo at 55° C. in the presence of phosphorous pentoxide and immediately transferred to a nitrogen glove box. The imidazole content of the resulting polymers was analyzed using NMR (DMSO-d₆ or CDCl₃, see FIG. 25).

TABLE 7
SEC results for the backbones synthesized for this study.

| Polymer backbone | Used for samples | Mₙ (kDa) | Ð |
|---|---|---|---|
| PVMS 1 | PVMS-Et-Im | 29 | 1.60 |
| PVMS 2 | PVMS-Phc-Im | 19 | 1.29 |

### Grafting Densities

### Solution-State NMR:

Grafting densities were determined by integration of NMR data. For the ethane-imidazole series, the imidazole peaks (located between 6.8 and 7.7 ppm) were compared with the integration of the methyl group on the siloxane backbone (located around 0.1 ppm):

$$\% imidazole grafting , PVMS - Et - Im = \frac{Imidazole {C}_{2} proton}{Backbone methyl protons / 3} \times 100 = \frac{300}{Backbone methyl protons} \qquad$$

For the phenyl-imidazole series, the ratio of the phenyl aromatic protons to imidazole aromatic protons was used. The phenyl protons overlap with one (or two, in the case of the 14% grafted) imidazole protons, and thus the following equations were used:

$$\% imidazole grafting , PVMS - Phc - Im = \frac{Imidazole {C}_{2} proton}{( Middle aromatic protons - 1 ) / 5} \times 100 = \frac{500}{ ( Middle aromatic protons - 1 )}$$

and for the 14%:

$$\% imidazole grafting , PVMS - Phc - Im 14 = \frac{Imidazole {C}_{2} proton}{( Middle aromatic protons - 2 ) / 5} \times 100 = \frac{500}{B ( Middle aromatic protons - 2 )}$$

Composition, Device, and Method Embodiments

Illustrative, non-exclusive examples of inventive subject matter according to the present disclosure are described in the following examples.

1. A polymer, comprising:

a plurality of repeat units, each of the repeat units including a backbone section; and

a plurality of side chains, each of the side-chains attached to a different one of the backbone sections, wherein:

at least some of the side chains include a spacer connected to a ligand moiety, the ligand moiety capable of bonding (e.g., ionically bonding) to or interacting with a cation so as to at least conduct or solvate the cation,

the spacer comprises moieties that do not ionically bond with the cation (e.g., the spacer consists or consists essentially of one or more non-polar moieties, one or more non-polar functional groups), and

the spacer is at least 4 atoms long, or has a length in a range of 4-20 atoms (chain of N atoms wherein 4≤N≤20, e.g., as illustrated in FIG. 1B).

2. The polymer of example 1, wherein the glass transition temperature is less than 40 degrees Celsius or less than 50 degrees Celsius.

3. The polymer of example 1, wherein the polymer has a glass transition temperature of 0 degrees Celsius or less than 0 degrees Celsius.

4. The polymer of example 1, wherein the polymer has a glass transition temperature of less than minus twenty degrees Celsius.

5. The polymer of example 1, wherein the spacers each consist essentially of, or only of, at least one of carbon, sulfur, silicon, phosphorus, or hydrogen (e.g., the N atoms in the chain of atoms comprise at least one of carbon, sulfur, silicon, or phosphorus).

6. The polymer of any of examples 1-4, wherein the spacer does not include nitrogen or oxygen.

7. The polymer of any of the examples 1-5, wherein the spacer comprises or consists essentially of, or only of, an aliphatic chain, alkane, an ether, a siloxane, or a thiol ether.

8. The polymer of any of the examples 1-6, wherein the ligand moiety comprises an electron rich group or a group comprising an electron lone pair.

9. The composition of matter of any of the examples 1-8, wherein the spacer does not include an amide.

10. The polymer of any of the examples 1-9, wherein the ligand moiety comprises an imidazole or cyano.

11. The polymer of any of the examples 1-10 having one of the following structures:

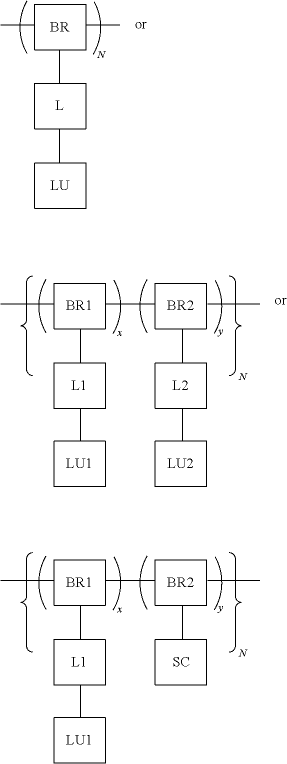

wherein BR, BR1, BR2 comprise the backbone section, L1 and SC comprise the spacer, and LU, LU1, LU2 comprise the ligand moiety.

12. The polymer of any of the examples 1-11, wherein the ligand moiety comprises at least one group selected from:

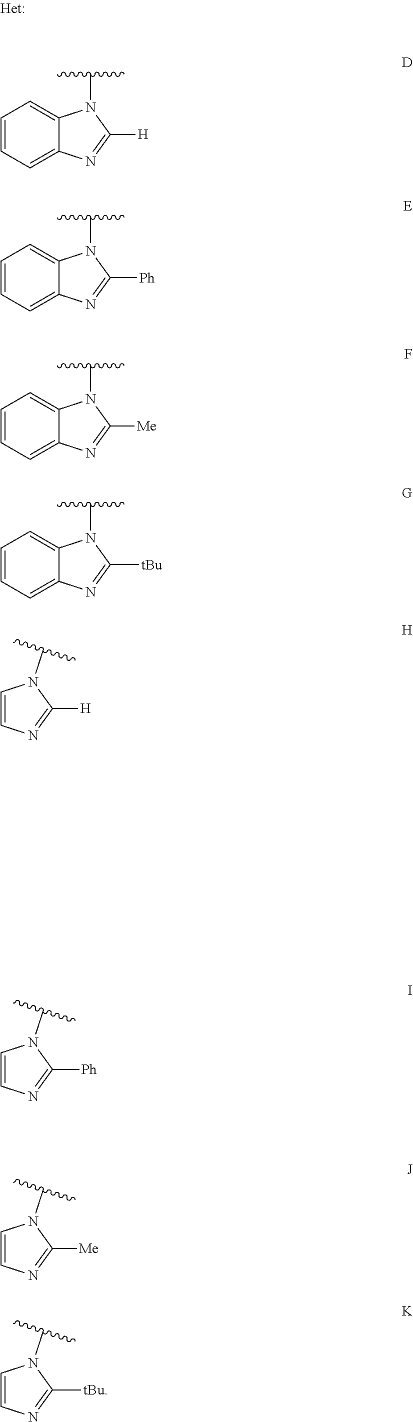

13. The polymer of any of the examples 1-11, wherein the ligand moiety comprises at least one group selected from:

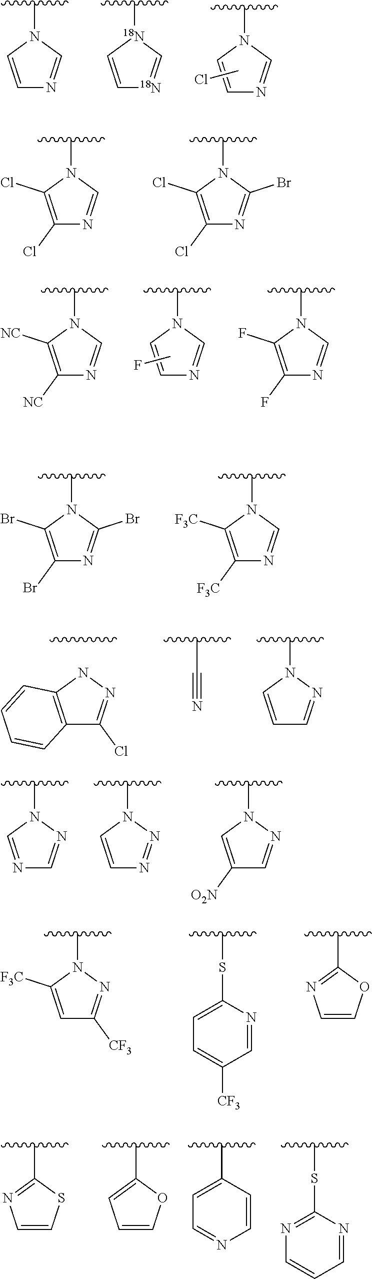

14. The polymer of any of the preceding examples, wherein the ligand moiety is grafted onto the backbone with a grafting density of 100% or less than 100%.

15. The polymer of any of the preceding examples, wherein the polymer has the ligand moiety content such that the Li⁺ to ligand moiety molar ratio MR is in a range of 0.03≤MR≤0.6, 0.07≤MR≤0.6, and 0.3≤MR≤0.4.

16. The polymer of any of the preceding examples, wherein the polymer has the ligand moiety such that the glass transition temperature is below 40 degrees Celsius and the polymer has the conductivity for the cation, comprising a lithium ion, of at least 10⁻⁵ cm⁻¹ (e.g., at the temperature of 30 degrees Celsius).

17. The polymer of any of the preceding examples, wherein the backbone section comprises one of the following:

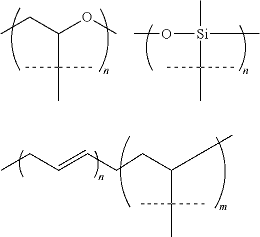

and n and m are integers in a range of 5-5000.

18. A polymer comprising the structure:

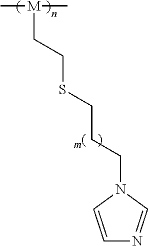

where m and n are integers, M is a monomer unit and S is Sulfur, Silicon or Carbon.

19. A polymer comprising a structure:

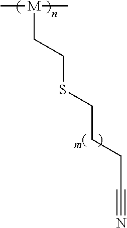

where m and n are integers, M is a monomer unit, and S is Sulfur, Silicon or Carbon.

20. The polymer of example 18 or 19, wherein m is in the range 5-15, 5-25, or such that the spacer has a length in a range of 4-20 atoms, or m can be in a range 0-15, which gives the whole linker or spacer having a length in a range 5-20 atoms.

21. The polymer of any of the examples, wherein the grafting density GD of the sidechains is 50%≤GD≤90%, 50%≤GD≤100%, 50%≤GD≤99%, 60%≤GD≤80%, 80%≤GD≤100%, 80%≤GD≤90%, 80%≤GD≤99%, 75%≤GD≤90%, or a combination thereof.

tailored for a conductivity of a Lithium ion in an electrolyte comprising the polymer.

22. The polymer of any of the examples 1-21, wherein a grafting density of the ligand moiety (e.g., imidazole) above a threshold value causes an increase in the system T_{g} but not an increase in ion mobility. Indeed, if the grafting density is too high, the resulting increase in T_{g} causes a net drop of ion conductivity. Thus, in some examples, grafting density is tuned so that the ligand content in the polymer is below a threshold value that undesirably reduces conductivity of the cation. In one or more examples, optimal or maximum conductivity at the operating temperature of the battery is achieved for the grafting density in a range of example 21.

23. The polymer of any of the examples, wherein increasing length of the spacer may increase flexibility of the polymer, because when a ligand moiety such as imidazole is too close to the polymer backbone, backbone flexibility (chain segmental dynamics, which affect T_{g}) will drop and polymer T_{g} will increase. Longer spacer may also increase solvation efficiency of the ligand since there's more flexibility for the ligands to move and rotate to better bind ions. However, in some examples, if the spacer is too long, conductivity may be reduced (because concentration of ligand moiety is reduced). Thus, in one or more examples, optimal or maximum conductivity is achieved for a length of the spacer in a range of 4-20 atoms and m as described in example 20 is adjusted accordingly (e.g., m can be in a range 0-15, which gives the whole linker or spacer having a length in a range 5-20 atoms).

24. The polymer of any of the examples 1-23, wherein not all the sidechains comprise the ligand moiety.

25. The polymer of any of the preceding examples 1-24, wherein the polymer comprises a bottlebrush polymer.

26. An electrolyte comprising the polymer of any of the preceding examples,

wherein the cation is Li⁺.

27. The electrolyte of example 26, further comprising an additive for increasing

the conductivity of the cation in the electrolyte.

28. A battery comprising the electrolyte of examples 26 or 27 in contact with an anode and a cathode.

29. The battery of example 28, wherein the polymer has the ligand moiety configured for solvating and conducting the cation comprising lithium ions in the electrolyte and having a glass transition temperature such that the polymer is in a solid state during operation of the lithium ion battery with the electrolyte comprising the polymer.

30. A method of making an electrolyte in a lithium ion battery comprising:

providing a polymer having a ligand moiety configured for solvating and conducting lithium ions in the electrolyte and having a glass transition temperature such that the polymer is in a solid state during operation of the lithium ion battery with the electrolyte comprising the polymer.

31. The method of example 30, further comprising controlling a grafting density or content of the ligand moiety so that the conductivity is at least 10⁻⁵ S cm⁻¹ at 30 degrees Celsius and the glass transition temperature is below 40 degrees Celsius.

32. The method of examples 30 or 31, further comprising using nuclear magnetic resonance to obtain a measurement of the solvation and the conductivity of the lithium ion as a function of the ligand moiety, and using the measurement to select the ligand moiety used in the electrolyte.

33. A method of making a composition of matter, comprising:

(a) combining at least one of an imidazole, pyrazole, triazole, pyridine, oxazole, thiazole, furan, nitrile, or pyrimidine, with an alkane to form a derivative;

(b) combining sulfur with the derivative to form a thiol; and

(c) combining the thiol with a polymer comprising a siloxane to form the polymer comprising a side chain including the thiol.

34. The method of example 33, wherein the combining (c) comprises a thiolene click reaction.

35. The method or composition of matter of any of the preceding examples 1-34, wherein the ligand moiety comprises at least one of nitrogen, oxygen, sulfur, or phosphorous.

36. The method or composition of matter of any of the preceding examples 1-35, wherein the ligand moiety comprises at least one compound selected from an amine, a cyano, a pyrrolidine, a pyrroline, a pyrrole, an imidazole, a pyrazole, a piperidine, a tetrahydropyridine, a pyridine, a pyrimidine, a pyrazine, a pyridazine, a naphthyridine, an azaindole, a substituted imidazole as listed in FIG. 6, a halogenated imidazole (2, or 4-fluoroimidazole, 2, or 4-chloroimidazole, 2, or 4-bromoimidazole, 2, or 4-iodoimidazole, bis or tris-fluoroimidazole, bis or tris-chloroimidazole), a tetrahydrofuran, a furan, an oxazole, an isoxazole, and a 1,2-, or 1,3-, or 1,4-dioxane.

37. The method or composition of matter of any of the preceding examples, wherein the cation comprises Li⁺.

38. A composition of matter or polymer manufactured using the method of any of the examples 30-37.

39. A composition of matter comprising the polymer of any of the examples 1-38.

40. The polymer of any of the examples 1-39, wherein the spacer comprises a linker group or moiety linking the ligand moiety to the backbone, wherein the linker moiety or linker group does not reduce the polymer's conductivity for the cation.

41. The polymer of any of the examples 1-40, wherein the linker group or linker moiety or spacer comprises a flexible compound.

42. The polymer of any of the examples 1-41, wherein the spacer consists essentially of carbon and hydrogen.

43. The polymer of any of the examples 1-42, wherein the ligand moiety is configured to have a coordination strength tailored to solvate (or dissolve) and conduct the cation.

44. The polymer of any of the examples 1-43, wherein the ligand moiety has the coordination strength such that the polymer has a conductivity for the cation, comprising a lithium ion, of more than 10⁻⁵ S cm⁻¹ (e.g., at 30 degrees Celsius).

45. The polymer of any of the examples 1-44, wherein the grafting density, content, and/or steric bulk of the ligand moiety is tailored for a desired conductivity and glass transition temperature of the cation comprising a lithium ion.

Advantages and Improvements

To dissolve and conduct ions, polymers must contain solvation groups which interact favorably with ions to promote their dissociation, without immobilizing the ions within the polymer framework. The competition between effective salt dissolution and labile ion-polymer interactions results in necessary tradeoffs in electrolyte design and performance. For example, both intermediate polymer polarity and salt concentration seem to provide maximum conductivity performance due to the complex interplay between ion-polymer interactions, segmental dynamics, and ion mobility. Most polymer electrolytes contain at least two mobile ions, the cation and anion, which both contribute to the total conductivity. Salt dissolution is generally achieved by coordination with the cationic species. For cation motion, these same coordination sites must be dynamic and allow the ion to hop through the matrix by breaking and reforming coordination bonds on a reasonable timescale. Anions typically interact less strongly with the polymer, but still rely on free volume or local polymer re-arrangement, which is in turn generally coupled to cation-polymer interactions since these interactions dynamically cross-link the polymer matrix and result in increases in polymer glass transition temperature (If). While energy storage applications require cation transport, most electrolytes exhibit higher anion than cation mobility, underscoring a current challenge for these materials. Polymer design thus requires the incorporation of functional solvation groups which provide strong yet dynamic interactions between the polymer and ions to enable higher cation mobility.

One class of materials with labile ion-polymer interactions is metal-ligand coordination polymers which we have previously shown to dissolve and conduct a range of metal salts relevant for energy storage. This family of polymers offers advantages in tunability through the wide range of possible combinations of polymer backbone and ligand choices which enables optimization of additional unexplored features for improving performance. One promising route towards improving ionic conductivity is to increase the segmental mobility of the electrolyte. This can be achieved through the choice of a polymer matrix with inherently low T_{g}. The lowest T_{g} polymers generally do not contain the necessary solvation sites for dissolving ions, requiring the introduction of tethered species for ion solvation. One effective way to introduce such solvating groups is by adding side-chains to a low T_{g} polymer backbone. This has been successfully demonstrated for siloxane,[13-15]phosphazene,[16] acrylate[17-20] and aliphatic[13] backbones. However, the attachment of side-chains to a low T_{g} polymer backbone generally increases the T_{g} of the electrolyte.[15,21,22] Thus, there is a trade-off between the inclusion of the necessary solvation sites for ion conduction and keeping a low T_{g}. Ideally, a minimal concentration of solvation sites would be added to a low T_{g} polymer backbone to achieve ion dissolution and conduction without increasing the T_{g} to a detrimental level.

Expanding polymer design towards the incorporation of functional groups with improved interactions with lithium salts requires a synthetic platform that enables rapid synthesis and ligand screening. A strategic method for the incorporation of ligand functional groups proceeds via thiolene click chemistry. However, within this framework, the attachment chemistry of the functional groups must be designed to eliminate any unwanted ion interactions. Here we disclose design rules for the synthesis of thiol-functionalized ligand moieties with the targeted removal of detrimental functional groups.

In one embodiment, the discovery pertains to the elimination of the amide functional group from the ligand-containing sidechains of ligand-grafted siloxane polymer electrolytes. The removal of the amide functional group was motivated through the expectation of lower polymer glass transition temperature (If) through the removal of the hydrogen bonding site. A lower polymer T_{g} has been shown to improve conductivity performance of polymer electrolytes. This embodiment of the invention has resulted in two orders of magnitude improvement in ionic conductivity of a model polymer electrolyte system due to both improvements in segmental dynamics, which contributed to roughly one order of magnitude conductivity improvement, as well as changes in ligand-ion interactions. This significant discovery suggests an important strategy for the design of ligand attachment chemistry to low-T_{g} polymer backbones, namely the removal of all functional groups or heteroatoms other than the ligand group of interest within the polymer sidechain. This ensures only the ligand moiety optimized for Li⁺ conductivity will interact with the dissolved salt ions, leading to an improvement in ionic conductivity.

Tuning the ligand grafting density of an imidazole side-chain siloxane polymer electrolyte doped with LiTFSI enables dramatic tunability over polymer glass transition temperature and total ionic conductivity. The choice of spacer unit, either ethane thiol or phenyl thiol, has significant impact on the ionic conductivity behavior, with the less bulky ethane spacer enabling an order of magnitude improvement in the total ionic conductivity. The T_{g}-normalized conductivity is shown to be constant at high imidazole grafting density, and decreases below a threshold imidazole content that can be correlated with an approximate volume fraction of imidazole. PFG-NMR enables measurement of Li⁺ transport numbers, which decrease slightly with decreasing imidazole content, likely due to poorer connectivity between neighboring coordination sites. These measurements also suggest ion pairing or incomplete salt dissociation. Relaxation NMR measurements indicate the existence of at least two ion environments, and prove useful for estimating t₊ at lower temperatures not accessible to PFG-NMR. This system presents further opportunities for tuning polymer electrolyte conductivity performance by reducing, rather than increasing, the total ligand content to a value that optimizes polymer T_{g}, ionic conductivity, and Li⁺ t₊.

In other examples, polymers may be designed with side chains comprising amides.

In one or more embodiments, the polymers have a general structure as shown in FIG. 15A, consisting of a polymer backbone (red), ion solvating and/or binding ligands (gray circles), and spacers (side chains) that tether/connect/graft the ligands to the polymer backbone (green). The polymers may optionally comprise non ion-solvating/binding terminal groups (yellow circles).

In one or more embodiments, the polymer backbone is selected to have a soft/flexible nature which gives the polymer low glass transition temperature T_{g}, fast segmental motion and improved ion conductivity. The polymer backbone can be selected from any low T_{g} polymers. The polymer backbone can be comprised of but not limited to poly(siloxane), poly(ether), poly(butadiene), poly(ethylene), poly(phosphazene), poly(acrylate), polycarbonate, polylactide or the combination thereof. The glass transition temperature of the polymers is preferred to be below room temperature, more preferred to be below 0° C., more preferred to be below −20° C., and more preferred to be below −44° C.

In one or more embodiments, the spacer (or linker) is selected to have a soft/flexible nature which gives the polymers low glass transition temperature T_{g}, fast segmental motion and improved ion conductivity. The spacer (linker) can be but not limited to an alkylene chain, an ethylene chain, a thioether chain, a siloxane chain or the combination thereof. The spacer can have 1 to 50 carbon atoms or the combination of carbon, oxygen, sulfur and silicon atoms. In one or more embodiments, the spacer contains more than four carbons. In one or more embodiments, the spacer does not contain an ion binding group. In some embodiments, the spacer does not contain an aromatic group. In some embodiments, the spacer does not contain a hydrogen bonding group. In some embodiments, the spacer does not contain an amide group.

In one or more embodiments, the ligands are selected to have a labile interaction with the ions or cations, with percolated networks for ion transport. The lability of ion-ligand interactions can be tuned by using different coordinating groups whose geometry or strength of interaction may increase the kinetics of ligand exchange. In one or more examples, variations on imidazole ligands with electron-withdrawing or bulky groups may increase ligand exchange rates. Further, weaker ligand chemistries including carbonyl, linear and cyclic aldehyde, linear and cyclic ketone, linear and cyclic ester, linear and cyclic carbonate and nitrile may also be used. Adding steric interference or electron withdrawing groups to the imidazole ligand may also further increase the kinetics of ion-ligand exchange.

In one or more examples, the sidechain comprises a linker having a weaker interaction with the cation compared to the ligand. In one or more examples, the binding ability of the ligand to the cation is optimized or tailored between too weak (where the salt won't dissolve) and too strong (where the cation will be relatively immobile). In one or more examples, adding steric bulk increases ligand exchange kinetics. In one or more examples, a linker is a linker moiety, linker group, or compound linking the ligand moiety to the backbone. In some examples, the linker may comprise a non-polar group.

The ligands can be selected from any ion-interacting atoms or functional groups. In one or more embodiments, the ligands contain one or more nitrogen, one or more oxygen, one or more sulfur, one or more phosphorous atoms or moieties or the combination thereof. In some embodiments, the ligands can include but not limited to the group of amine, cyano, nitrile, pyrrolidine, pyrroline, pyrrole, imidazole, pyrazole, piperidine, tetrahydropyridine, pyridine, pyrimidine, pyrazine, pyridazine, naphthyridine, azaindole, triazole, thiazole, triazine, substituted imidazole as listed in FIG. 6-8, halogenated imidazole (2, or 4-fluoroimidazole, 2, or 4-chloroimidazole, 2, or 4-bromoimidazole, 2, or 4-iodoimidazole, bis or tris-fluoroimidazole, bis or tris-chloroimidazole), tetrahydrofuran, furan, oxazole, isoxazole, 1,2-, or 1,3-, or 1,4-dioxane, trioxane, dioxolane or combination thereof. The ligands mentioned here can be further substituted with alkyl, alkoxy, cyano, nitro, sulfonyl, perfluoroalkyl, trifluoromethyl, aromatic groups or halogens. In one or more examples, the ligand is covalently bonded to a linker through one of its nitrogen atoms. In one or more examples, the ligand is covalently bonded to a linker through one of its carbon atoms.

The ions (salt) added can be selected from any organic, inorganic or hybrid monovalent, divalent, trivalent, tetravalent, pentavalent, hexavalent or higher valent ions or their combinations. In one or more embodiments, the ions (cations) can be selected from but not limited to the group of H⁺, H₃O⁺, NH₄⁺, H₃NOH⁺, Li⁺, Na⁺, K⁺, Rb⁺, Cs⁺, Cu⁺, Ag⁺, BiO⁺, methylammonium CH₃NH₃⁺, ethylammonium (C₂H₅)NH₃⁺, alkylammonium, formamidinium NH₂(CH)NH₂⁺, guanidinium C(NH₂)₃⁺, imidazolium C₃N₂H₅⁺, hydrazinium H₂N—NH₃⁺ azetidinium (CH₂)₃NH₂⁺, dimethylammonium (CH₃)₂NH₂⁺, tetramethylammonium (CH₃)₄N⁺, phenyl ammonium C₆H₅NH₃⁺, arylammonium, heteroarylammonium, Mg²⁺, Ca²⁺, Sr²⁺, Ba²⁺, Ti²⁺, V²⁺, Ni²⁺, Cr²⁺, Co²⁺, Fe²⁺, Sn²⁺, Cu²⁺, Ag²⁺, Zn²⁺, Mn²⁺, NH₃CH₂CH₂NH₃²⁺, NH₃(CH₂)₆NH₃²⁺, NH₃(CH₂)₈NH₃²⁺ and NH₃C₆H₄NH₃²⁺, Al³⁺, Cr³⁺, Fe³⁺, Bi³⁺, Sb³⁺, and the combination thereof.

In one or more embodiments, the ions (anions) can be selected from but not limited to the group of hexafluoroarsenate (AsF₆⁻), perchlorate (ClO₄⁻), hexafluorophosphate (PF₆⁻), tetrafluorob orate (BF₄⁻), trifluoromethanesulfonate or triflate (Tf⁻) (CF₃SO₃⁻), bis(fluorosulfonyl)imide (FSI⁻) and bis(trifluoromethanesulfonyl)imide (TFSI⁻). More examples can be found in various battery related literature [7], In one or more examples, salt to ligand mole ratio or salt to polymer backbone monomer mole ratio is in a range of 0.01 to 1.5, or 0.03 to 0.6, or 0.07 to 0.6, or 0.3 to 0.4, or 0.6, 0.4, 0.3, 0.1, 0.05, 0.03 or 0.01.

Grafting density of the ligands may vary from 0% to 100%. The grafting density can be rationally adjusted to give the highest ion conductivity.

In one or more examples, the polymer electrolyte has an ion conductivity of at least 10⁻⁵ S cm⁻¹ at 30 degrees or room temperature. In one or more examples, the polymer electrolyte has an ion conductivity of at least 5×10⁻⁵ S cm⁻¹ at 30 degrees or room temperature.

In one or more examples, the polymer electrolyte has a Li⁺ transport number>0.3. In one or more examples, the polymer electrolyte has a Li⁺ transport number>0.4. In one or more examples, the polymer electrolyte has a Li⁺ transport number>0.5. In one or more examples, the polymer electrolyte has a less than 10% change of Li⁺ transport number change in the temperature range of 10-90° C.

The ligands may interact dynamically via ion-ligand coordination with the ion species to form transient cross-linked networks while retaining the ability to conduct those ions, so as to increase the ion conductivity and polymer mechanical properties simultaneously. In one or more embodiments, the polymer backbone, spacer and ligand are selected independently to optimize the ion conductivity and polymer mechanical properties simultaneously.

### REFERENCES FOR FIRST EXAMPLE

The following references are incorporated by reference herein
(1) Tarascon, J.-M.; Armand, M. Issues and challenges facing rechargeable lithium batteries. Nature 2001, 414, 359-367.
(2) Quartarone, E.; Mustarelli, P. Electrolytes for solid-state lithium rechargeable batteries: Recent advances and perspectives. Chem. Soc. Rev. 2011, 40, 2525-2540.
(3) Manthiram, A.; Yu, X.; Wang, S. Lithium battery chemistries enabled by solid-state electrolytes. Nat. Rev. Mater. 2017, 2, 16103.
(4) Hallinan, D. T.; Balsara, N. P. Polymer Electrolytes. Annu. Rev. Mater. Res. 2013, 43, 503-525. 321
(5) Goodenough, J. B.; Kim, Y. Challenges for Rechargeable Li Batteries. Chem. Mater. 2010, 22, 587-603. 323
(6) Hooper, R.; Lyons, L. J.; Mapes, M. K.; Schumacher, D.; Moline, D. A.; West, R. Highly Conductive Siloxane Polymers. Macromolecules 2001, 34, 931-936.
(7) Pesko, D. M.; Timachova, K.; Bhattacharya, R.; Smith, M. C.; Villaluenga, I.; Newman, J.; Balsara, N. P. Negative Transference Numbers in Poly(ethylene oxide)-Based Electrolytes. J. Electrochem. Soc. 2017, 164, E3569-E3575.
(8) Ma, Y.; Doyle, M.; Fuller, T. F.; Doeff, M. M.; De Jonghe, L. C.; Newman, J. The Measurement of a Complete Set of Transport Properties for a Concentrated Solid Polymer Electrolyte Solution. J. 333 Electrochem. Soc. 1995, 142, 1859-1868.
(9) Pozyczka, K.; Marzantowicz, M.; Dygas, J. R.; Krok, F. Ionic Conductivity and Lithium Transference Number of Poly(ethylene oxide):LiTFSI System. Electrochim. Acta 2017, 227, 127-135.
(10) Schauser, N. S.; Sanoja, G. E.; Bartels, J. M.; Jain, S. K.; Hu, J. G.; Han, S.; Walker, L. M.; Helgeson, M. E.; Seshadri, R.; Segalman, R. A. Decoupling Bulk Mechanics and Mono- and Multivalent Ion Transport in Polymers Based on Metal-Ligand Coordination. Chem. Mater. 2018, 30, 5759-5769. 342
(11) Mindemark, J.; Lacey, M. J.; Bowden, T.; Branded, D. Beyond PEO□ Alternative Host Materials for Li+-Conducting Solid Polymer Electrolytes. Prog. Polym. Sci. 2018, 81, 114-143.
(12) Lai, J.-C.; Jia, X.-Y.; Wang, D.-P.; Deng, Y.-B.; Zheng, P.; Li, C.-H.; Zuo, I-L.; Bao, Z. Thermodynamically stable whilst kinetically labile coordination bonds lead to strong and tough self-healing polymers. Nat. Commun. 2019, 10, 1164.
(13) Grindy, S. C.; Lenz, M.; Holten-Andersen, N. Engineering Elasticity and Relaxation Time in Metal-Coordinate Cross-Linked Hydrogels. Macromolecules 2016, 49, 8306-8312.
(14) Mozhdehi, D.; Ayala, S.; Cromwell, O. R.; Guan, Z. Self-Healing Multiphase Polymers via Dynamic Metal-Ligand Interactions. J. Am. Chem. Soc. 2014, 136, 16128-16131.
(15) Rao, Y.-L.; Chortos, A.; Pfattner, R.; Lissel, F.; Chiu, Y.-C.; Feig, V.; Xu, J.; Kurosawa, T.; Gu, X.; Wang, C.; He, M.; Chung, J. W.; Bao, Z. Stretchable Self-Healing Polymeric Dielectrics Cross-Linked Through Metal-Ligand Coordination. J. Am. Chem. Soc. 2016, 138, 6020-6027.
(16) Schauser, N. S.; Grzetic, D. J.; Tabassum, T.; Kliegle, G. A.; Le, M. L.; Susca, E. M.; Antoine, S.; Keller, T. J.; Delaney, K. T.; Han, S.; Seshadri, R.; Fredrickson, G. H.; Segalman, R. A. The Role of Backbone Polarity on Aggregation and Conduction of Ions in Polymer Electrolytes. J. Am. Chem. Soc. 2020, 142, 7055-7065.
(17) Sanoja, G. E.; Schauser, N. S.; Bartels, J. M.; Evans, C. M.; Helgeson, M. E.; Seshadri, R.; Segalman, R. A. Ion Transport in Dynamic Polymer Networks Based on Metal-Ligand Coordination: Effect of Cross-Linker Concentration. Macromolecules 2018, 51, 2017-2026.
(18) Fenton, D. E.; Parker, J. M.; Wright, P. V. Complexes of Alkali Metal Ions with Poly(ethylene Oxide). Polymer 1973, 14, 589.
(19) Ratner, M. A.; Shriver, D. F. Ion Transport in Solvent-Free Polymers. Chem. Rev. 1988, 88, 109-124. 374
(20) Bocharova, V.; Sokolov, A. P. Perspectives for Polymer Electrolytes: A View from Fundamentals of Ionic Conductivity. Macromolecules 2020, 53, 4141-4157. 377
(21) Savoie, B. M.; Webb, M. A.; Miller, T. F. Enhancing Cation Diffusion and Suppressing Anion Diffusion via Lewis-Acidic Polymer Electrolytes. J. Phys. Chem. Lett. 2017, 8, 641-646.
(22) Borodin, O.; Smith, G. D. Li+ Transport Mechanism in Oligo(Ethylene Oxide)s Compared to Carbonates. J. Solution Chem. 2007, 36, 803-813. 383
(23) Mongcopa, K. S. I.; Tyagi, M.; Mailoa, J. P.; Samsonidze, G.; Kozinsky, B.; Mullin, S. A.; Gribble, D. A.; Watanabe, H.; Balsara, N. P. Relationship between Segmental Dynamics Measured by Quasi-Elastic Neutron Scattering and Conductivity in Polymer Electrolytes. ACS Macro Lett. 2018, 7, 504-508
(24) Wang, Y.; Fan, F.; Agapov, A. L.; Saito, T.; Yang, J.; Yu, X.; Hong, K.; Mays, J.; Sokolov, A. P. Examination of the fundamental relation between ionic transport and segmental relaxation in polymer electrolytes. Polymer 2014, 55, 4067-4076.
(25) Further information on one or more embodiments of the present invention can be found at https://dx.doi.org/10.1021/acsmacrolett.0c00788.

### REFERENCES FOR FOURTH EXAMPLE

The following references are incorporated by reference herein
(1) Ratner, M. A.; Shriver, D. F. Ion Transport in Solvent-Free Polymers. Chem. Rev 1988, 88, 109-124.
(2) Hallinan, D. T.; Balsara, N. P. Polymer Electrolytes. Annu. Rev. Mater. Res 252013, 43, 503-525.
(3) Goodenough, J. B.; Kim, Y. Challenges for Rechargeable Li Batteries. Chem. Mater 2010, 22, 587-603.
(4) Borodin, O.; Smith, G. D. Li+ Transport Mechanism in Oligo(Ethylene Oxide)s Compared to Carbonates. J Solut. Chem 2007, 36, 803-813.
(5) Schauser, N. S.; Sanoja, G. E.; Bartels, J. M.; Jain, S. K.; Hu, J. G.; Han, S.; Walker, L. M.; Helgeson, M. E.; Seshadri, R.; Segalman, R. A. Decoupling Bulk Mechanics and Mono- and Multivalent Ion Transport in Polymers Based on Metal-Ligand Coordination. Chem. Mater. 2018, 30, 5759-5769.
(6) Diddens, D.; Heuer, A.; Borodin, O. Understanding the Lithium Transport within a Rouse-Based Model for a PEO/LiTFSI Polymer Electrolyte. Macromolecules 2010, 43, 2028-2036.
(7) Wheatle, B. K.; Lynd, N. A.; Ganesan, V. Effect of Polymer Polarity on Ion Transport: A Competition between Ion Aggregation and Polymer Segmental Dynamics. ACS Macro Lett. 2018, 7, 1149-1154.
(8) Sanoja, G. E.; Schauser, N. S.; Bartels, J. M.; Evans, C. M.; Helgeson, M. E.; Seshadri, R.; Segalman, R. A. Ion Transport in Dynamic Polymer Networks Based on Metal-Ligand Coordination: Effect of Cross-Linker Concentration. Macromolecules 2018, 51, 2017-2026.
(9) Panday, A.; Mullin, S.; Gomez, E. D.; Wanakule, N.; Chen, V. L.; Hexemer, A.; Pople, J.; Balsara, N. P. Effect of Molecular Weight and Salt Concentration on Conductivity of Block Copolymer Electrolytes. Macromolecules 2009, 42, 4632-4637.
(10) Lascaud, S.; Perrier, M.; Vallke, A.; Besner, S.; Prud'homme, J.; Armand, M. Phase Diagrams and Conductivity Behavior of Poly(ethylene oxide)-Molten Salt Rubbery Electrolytes. Macromolecules 1994, 27, 7469-7477.
(11) Pesko, D. M.; Timachova, K.; Bhattacharya, R.; Smith, M. C.; Villaluenga, I.; Newman, J.; Balsara, N. P. Negative Transference Numbers in Poly(ethylene oxide)-Based Electrolytes. J. Electrochem. Soc. 2017, 164, E3569-E3575.
(12) Lai, J.-C.; Jia, X.-Y.; Wang, D.-P.; Deng, Y.-B.; Zheng, P.; Li, C.-H.; Zuo, J.-L.; Bao, Z. Thermodynamically stable whilst kinetically labile coordination bonds lead to strong and tough self-healing polymers. Nat. Commun. 2019, 10, 1164.
(13) Schauser, N. S.; Grzetic, D. J.; Tabassum, T.; Kliegle, G. A.; Le, M. L.; Susca, E. M.; Antoine, S.; Keller, T. J.; Delaney, K. T.; Han, S.; Seshadri, R.; Fredrickson, G. H.; Segalman, R. A. The Role of Backbone Polarity on Aggregation and Conduction of Ions in Polymer Electrolytes. J. Am. Chem. Soc 2020, 142, 7055-7065.
(14) Hooper, R.; Lyons, L. J.; Mapes, M. K.; Schumacher, D.; Moline, D. A.; West, R. Highly Conductive Siloxane Polymers. Macromolecules 2001, 34, 931-936.
(15) Persson, J. C.; Jannasch, P. Intrinsically Proton-Conducting Benzimidazole Units Tethered to Polysiloxanes. Macromolecules 2005, 38, 3283-3289.
(16) Abraham, K. M.; Alamgir, M. Dimensionally Stable MEEP-Based Polymer Electrolytes and Solid-State Lithium Batteries. Chem Mater 1991, 3, 339-348.
(17) Kobayashi, N.; Uchiyama, M.; Shigehara, K.; Tsuchida, E. Ionically High Conductive Solid Electrolytes Composed of Graft Copolymer-Lithium Salt Hybrids. J. Phys. Chem 1985, 89, 987-991.
(18) Morita, M.; Fukumasa, T.; Motoda, M.; Tsutsumi, H.; Matsuda, Y.; Takahashi, T.; Ashitaka, H. Polarization Behavior of Lithium Electrode in Solid Electrolytes Consisting of a Poly(Ethylene Oxide)-Grafted Polymer. J. Electrochem. Soc 1990, 137.
(19) Trapa, P. E.; Won, Y.-Y.; Mui, S. C.; Olivetti, E. A.; Huang, B.; Sadoway, D. R.; Mayes, A. M.; Dallek, S. Rubbery Graft Copolymer Electrolytes for Solid-State, Thin-Film Lithium Batteries. J Electrochem Soc 2005, 152, A1-A5.
(20) Bergman, M.; Bergfelt, A.; Sun, B.; Bowden, T.; Branded, D.; Johansson, P. Graft Copolymer Electrolytes for High Temperature Li-Battery Applications, Using Poly(methyl methacrylate) Grafted Polyethylene glycol)methyl ether methacrylate and Lithium Bis(trifluoromethanesulfonimide). Electrochim. Acta 2015, 175, 96-103.
(21) Karlsson, C.; Jannasch, P. Highly Conductive Nonstoichiometric Protic Poly(ionic liquid) Electrolytes. ACS Appl. Energy Mater. 2019, 2, 6841-6850.
(22) Granados-Focil, S.; Woudenberg, R. C.; Yavuzcetin, O.; Tuominen, M. T.; Coughlin, E. B. Water-Free Proton-Conducting Polysiloxanes: A Study on the Effect of Heterocycle Structure. Macromolecules 2007, 40, 8708-8713.
(23) Webb, M. A.; Savoie, B. M.; Wang, Z.-G.; Miller III, T. F. Chemically Specific Dynamic Bond Percolation Model for Ion Transport in Polymer Electrolytes. Macromolecules 2015, 48, 7346-7358.
(24) Pesko, D. M.; Jung, Y.; Hasan, A. L.; Webb, M. A.; Coates, G. W.; Miller III, T. F.; Balsara, N. P. Effect of Monomer Structure on Ionic Conductivity in a Systematic Set of Polyester Electrolytes. Solid State Ionics 2016, 289, 118-124.
(25) Buitrago, C. F.; Bolintineanu, D. S.; Seitz, M. E.; Opper, K. L.; Wagener, K. B.; Stevens, M. J.; Frischknecht, A. L.; Winey, K. I. Direct Comparisons of X-ray Scattering and Atomistic Molecular Dynamics Simulations for Precise Acid Copolymers and Ionomers. Macromolecules 2015, 48, 1210-1220.
(26) Hall, L. M.; Stevens, M. J.; Frischknecht, A. L. Effect of Polymer Architecture and Ionic Aggregation on the Scattering Peak in Model Ionomers. Phys. Rev. Lett. 2011, 106, 127801.
(27) Frischknecht, A. L.; Paren, B. A.; Middleton, L. R.; Koski, J. P.; Tarver, J. D.; Tyagi, M.; Soles, C. L.; Winey, K. I. Chain and Ion Dynamics in Precise Polyethylene Ionomers. Macromolecules 2019, 52, 7939-7950.
(28) Druger, S. D.; Nitzan, A.; Ratner, M. A. Dynamic Bond Percolation Theory: A Microscopic Model for Diffusion in Dynamically Disordered Systems. I. Definition and One-Dimensional Case. J. Chem. Phys 1983, 79, 3133-3142.
(29) Druger, S. D.; Ratner, M. A.; Nitzan, A. Polymeric Solid Electrolytes: Dynamic Bond Percolation and Free Volume Models for Diffusion. Solid State Ionics 1983, 9, 1115-1120.
(30) Druger, S. D.; Ratner, M. A.; Nitzan, A. Generalized Hopping Model for Frequency-Dependent Transport in a Dynamically Disordered Medium, with Applications to Polymer Solid Electrolytes. Phys. Rev. B 1985, 31, 3939-3947.
(31) Nitzan, A.; Ratner, M. A. Conduction in Polymers: Dynamic Disorder Transport. J. Phys. Chem 1994, 98, 1765-1775.
(32) Mindemark, J.; Lacey, M. J.; Bowden, T.; Branded, D. Beyond PEO—Alternative Host Materials for Li+-Conducting Solid Polymer Electrolytes. Prog. Polym. Sci. 2018, 81, 114-143.
(33) Doyle, M.; Fuller, T. F.; Newman, J. The Importance of the Lithium Ion Transference Number in Lithium/Polymer Cells. Electrochim. Acta 1994, 39, 2073-2081.
(34) Schauser, N. S.; Seshadri, R.; Segalman, R. A. Multivalent Ion Conduction in Solid Polymer Systems. Mol. Syst. Des. Eng 2019, 4, 263-279.
(35) Bruce, P. G.; Vincent, C. A. Steady State Current Flow in Solid Binary Electrolyte Cells. J. Electroanal. Chem 1987, 225, 1-17.
(36) Bruce, P. G.; Vincent, C. A. Effect of Ion Association on Transport in Polymer Electrolytes. Faraday Discuss. Chem. Soc 1989, 88, 43-54.
(37) Balsara, N. P.; Newman, J. Relationship between Steady-State Current in Symmetric Cells and Transference Number of Electrolytes Comprising Univalent and Multivalent Ions. J. Electrochem. Soc. 2015, 162, A2720-A2722.
(38) Ma, Y.; Doyle, M.; Fuller, T. F.; Doeff, M. M.; De Jonghe, L. C.; Newman, J. The Measurement of a Complete Set of Transport Properties for a Concentrated Solid Polymer Electrolyte Solution. J Electrochem Soc 1995, 142, 1859-1868.
(39) Arumugam, S.; Shi, J.; Tunstall, D. P.; Vincent, C. A. Cation and Anion Diffusion Coefficients in a Solid Polymer Electrolyte Measured by Pulsed-Field-Gradient Nuclear Magnetic Resonance. J. Phys. Condens. Matter 1993, 5, 153-160.
(40) Runt, J.; Fitzgerald, J. J. Dielectric Spectroscopy of Polymeric Materials: Fundamentals and Applications.; American Chemical Society, 1997.
(41) Fox, T. G.; Loshaek, S. Influence of Molecular Weight and Degree of Crosslinking on the Specific Volume and Glass Temperature of Polymers. J. Polym. Sci. 1955, 15, 371-390.
(42) Scher, H.; Zallen, R. Critical Density in Percolation Processes. J. Chem. Phys. 1970, 53, 3759-3761.
(43) Wang, Y.; Fan, F.; Agapov, A. L.; Yu, X.; Hong, K.; Mays, J.; Sokolov, A. P. Design of Superionic Polymers—New Insights from Walden Plot Analysis. Solid State Ionics 2014, 262, 782-784.
(44) Stacy, E. W.; Gainaru, C. P.; Gobet, M.; Wojnarowska, Z.; Bocharova, V.; Greenbaum, S. G.; Sokolov, A. P. Fundamental Limitations of Ionic Conductivity in Polymerized Ionic Liquids. Macromolecules 2018, 51, 8637-8645.
(45) Bresser, D.; Lyonnard, S.; Iojoiu, C.; Picard, L.; Passerini, S. Decoupling Segmental Relaxation and Ionic Conductivity for Lithium-Ion Polymer Electrolytes. Mol. Syst. Des. Eng. 2019, 4, 779-792.
(46) Iacob, C.; Matsumoto, A.; Brennan, M.; Liu, H.; Paddison, S. J.; Urakawa, O.; Inoue, T.; Sangoro, J.; Runt, J. Polymerized Ionic Liquids: Correlation of Ionic Conductivity with Nanoscale Morphology and Counterion Volume. ACS Macro Lett. 2017, 6, 941-946.

### FURTHER REFERENCES

The following references are incorporated by reference herein.
1. Wang, L.; Zhou, Z.; Yan, X.; Hou, F.; Wen, L.; Luo, W.; Liang, J.; Dou, S. X., Engineering of Lithium-Metal Anodes Towards a Safe and Stable Battery. Energy Storage Mater. 2018, 14, 22-48.
2. Hallinan, D. T.; Balsara, N. P., Polymer Electrolytes. Annu. Rev. Mater. Res 2013, 43, 503-25.
3. Sangoro, J. R.; Iacob, C.; Agapov, A. L.; Wang, Y.; Berdzinski, S.; Rexhausen, H.; Strehmel, V.; Friedrich, C.; Sokolov, A. P.; Kremer, F., Decoupling of Ionic Conductivity from Structural Dynamics in Polymerized Ionic Liquids. Soft Matter 2014, 10, 3536-3540.
4. Sanoja, G. E.; Schauser, N. S.; Bartels, J. M.; Evans, C. M.; Helgeson, M. E.; Seshadri, R.; Segalman, R. A., Ion Transport in Dynamic Polymer Networks Based on Metal-Ligand Coordination: Effect of Crosslinker Concentration. Macromolecules 2018, 51, 2017-2026.
5. Schauser, N. S.; Sanoja, G. E.; Bartels, J. M.; Jain, S. K.; Hu, J. G.; Han, S.; Walker, L. M.; Helgeson, M. E.; Seshadri, R.; Segalman, R. A., Decoupling Bulk Mechanics and Mono- and Multivalent Ion Transport in Polymers Based on Metal-Ligand Coordination. Chemistry of Materials 2018, 30, 5759-5769.
6. J. Mindemark, M. J. Lacey, T. Bowden and D. Branded, Beyond PEO—Alternative Host Materials for Li+-Conducting Solid Polymer Electrolytes, Prog. Polym. Sci., 2018, 81, 114-143.
7. Energy Environ. Sci., 2015, 8, 1905.
8. Further information on one or more embodiments of the present invention can be found in “Glass Transition Temperature and Ion Binding Determine Conductivity and Lithium-Ion Transport in Polymer Electrolytes” by Nicole S. Schauser, Andrei Nikolaev, Peter M. Richardson, Shuyi Xie, Keith Johnson, Ethan M. Susca, Hengbin Wang, Ram Seshadri, Raphaële J. Clément, Javier Read de Alaniz, and Rachel A. Segalman, https://dx.doi.org/10.1021/acsmacrolctt.0c0078, ACS MacroLetts, and supplemental information.

### Nomenclature

Some of the compounds are defined as in the following references:

Siloxane ether: Hooper, Lyons, Mapes, Schumacher, Moline and West, Highly Conductive Siloxane Polymers. Macromolecules 34 (2001) 931-936

Siloxane carbonate: Zhu, Einset, Yang, Chen, and Wnek, Synthesis of Polysiloxanes Bearing Cyclic Carbonate Side Chains. Dielectric Properties and Ionic Conductivities of Lithium Triflate Complexes. Macromolecules 27 (1994) 4076-4079

Ether backbone: DOI: 10.1016/0013-4686(92)80115-3, DOI 10.1557/JMR.2000.0281, own work

MEEP: doi:10.1016/j.ssi.2010.09.051

An-co-BuA: https://doi.org/10.1016/j.electacta.2015.04.023

Ethylene carbonate: doi: 10.1039/c3cc49588d

Ether imidazole and Butadiene imidazole: own work

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A polymer, comprising:
a plurality of repeat units, each of the repeat units including a backbone section; and
a plurality of side chains, each of the side-chains attached to a different one of the backbone sections, wherein:
at least, some of the side chains include a spacer connected to a ligand moiety, the ligand moiety configured to bond to, or interact with, a cation so as to at least solvate or conduct the cation,
the spacer does not conduct or solvate the cation, and
the spacer is 4 atoms-20 atoms long.

2. The polymer of claim 1, wherein the glass transition temperature is less than 40 degrees Celsius or less than 50 degrees Celsius.

3. The polymer of claim 1, wherein the spacer at least:
does not include nitrogen or oxygen, or
consists essentially of at least one of carbon, silicon, sulfur, phosphorus, hydrogen.

4. The polymer of claim 1, wherein the spacer comprises at least one of an alkane, an ether, a siloxane, a thiol ether.

5. The polymer of claim 1, wherein the ligand moiety comprises an electron rich group or a group comprising an electron lone pair.

6. The polymer of claim 1, wherein the spacer does not include an amide.

7. The polymer of claim 1, wherein the ligand moiety comprises an imidazole or cyano.

8. The polymer of claim 1, wherein the polymer has one of the following structures: 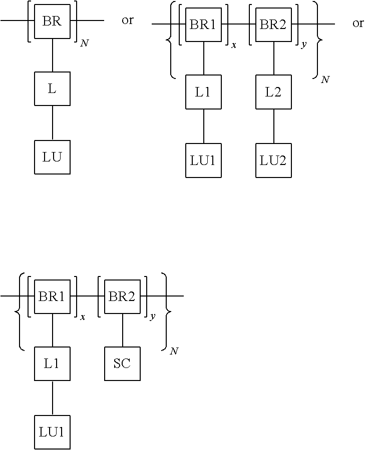
wherein BR, BR1, BR2 comprise the backbone section, L1 and SC comprise the spacer, LU, LU1, LU2 comprise the ligand moiety, and x, y, and N are integers and wherein the ligand moiety comprises at least one group selected from:

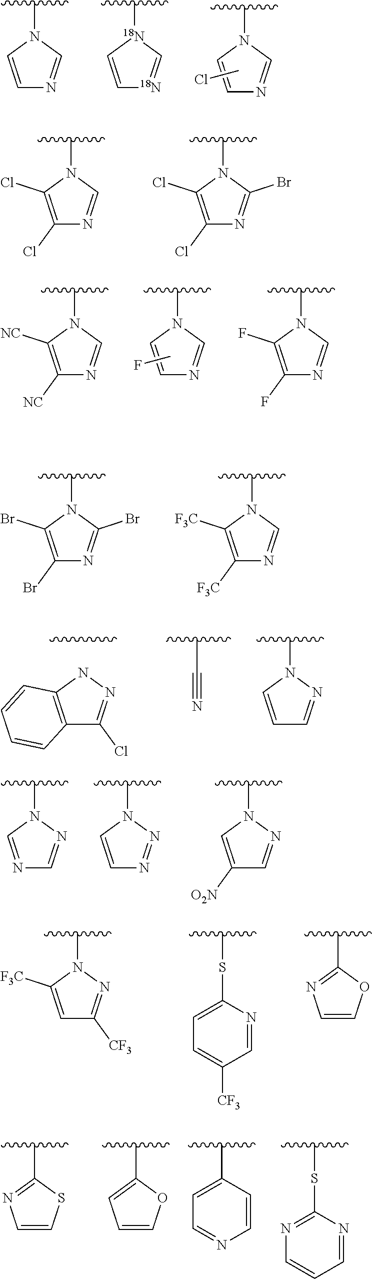

9. The polymer of claim 8, wherein the backbone section comprises one of the following: 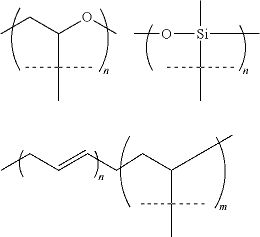
and n and m are integers in a range of 5-5000.

10. The polymer of claim 1, wherein:
the polymer has a ligand moiety content such that the Li⁺ to ligand moiety molar ratio in an electrolyte comprising the polymer is in a range of 0.07 and 0.6, and/or
the polymer has a ligand moiety such that the glass transition temperature is below 40 degrees Celsius and the polymer has the conductivity for the cation, comprising a lithium ion, of at least 10⁻⁵ cm⁻¹ at the temperature of 30 degrees Celsius.

11. The polymer of claim 1, wherein the grafting density of the sidechains is in a range of 50% to 90% and is tailored for a conductivity of a Lithium ion in an electrolyte comprising the polymer.

12. The polymer of claim 1, wherein not ail the sidechains comprise the ligand moiety.

13. The polymer of claim 1, wherein the polymer comprises a bottlebrush polymer.

14. An electrolyte comprising the polymer of claim 1, wherein the cation is Li⁺.

15. The electrolyte of claim 14, further comprising an additive for increasing the conductivity of the cation in the electrolyte.

16. A battery comprising the electrolyte of claim 14 in contact with an anode and a cathode, wherein the polymer has the ligand moiety configured for solvating and conducting the lithium ions in the electrolyte and having a glass transition temperature such that the polymer is in a solid state during operation of the lithium ion batten with the electrolyte comprising the polymer.

17. A polymer comprising the structure: 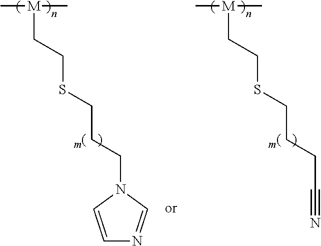
where m and n are integers, M is a monomer unit, and S is Sulfur or Carbon.

18. The polymer of claim 17, wherein m is in the range 5-15 or 4-20.

19. A method of making an electrolyte in a lithium ion battery comprising:
providing a polymer having a ligand moiety configured for solvating and conducting lithium ions in the electrolyte and having a glass transition temperature such that the polymer is in a solid state during operation of the lithium ion battery with the electrolyte comprising the polymer; and
controlling a grafting density or content of the ligand moiety so that the conductivity is at least 10⁻⁵ S cm⁻¹ at 30 degrees Celsius and the glass transition temperature is below 40 degrees Celsius.

20. The method of claim 19, wherein providing the polymer comprises:
(a) combining at least one of an imidazole, pyrazole, triazole, pyridine, oxazole, thiazole, furan, nitrile, or pyrimidine, with an alkane to form a derivative;
(b) combining sulfur with the derivative to form a thiol; and
(c) combining the thiol with a polymer comprising a siloxane to form the polymer comprising a side chain including the thiol, wherein the combining (c) comprises a thiolene click reaction.
